(19) United States
(12) Patent Application Publication
(10) Pub. No.: US 2026/0306361 A1
(43) Pub. Date: Oct. 8, 2026

(54) MEDICINE VIAL

(71) Applicant: BERRY GLOBAL, INC., Evansville, IN (US)

(72) Inventors: Roy E. ACKERMAN, Evansville, IN (US); Cindy ANSLINGER, Evansville, IN (US); Mark A. DEUTSCH, Haubstadt, IN (US); Jack DOOLITTLE, Evansville, IN (US)

(21) Appl. No.: 19/637,639

(22) Filed: Apr. 2, 2026

Related U.S. Application Data
(60) Provisional application No. 63/782,227, filed on Apr. 2, 2025.

(51) Int. Cl. A61J 1/14

(52) U.S. Cl. CPC A61J 1/1425; A61J 1/1418

(57) ABSTRACT

A vial comprises a vial body, a lip, and at least one closure retainer. The vial body includes a side wall and a floor. The lip extends radially out from the side wall. A lower edge of the lip forms a lip flange. The at least one closure retainer is coupled to the lip flange and includes an attachment member coupled and extending radially away from the lip flange and a ramp member coupled to and extending axially away from the attachment member towards the floor of the vial and parallel to the side wall. A radially outer surface of the side wall, a radially inner surface of the ramp member, and a radially extending surface of the attachment member defining a space between the ramp member and the side wall.

### PRIORITY CLAIM

This application claims priority under 35 U.S.C. § 119(e) to U.S. Provisional Patent Application No. 63/782,227, filed Apr. 2, 2025, which is expressly incorporated by reference herein in its entirety.

### BACKGROUND

The present disclosure relates to packaging, and particularly to medical packaging. More particularly, the present disclosure relates to child-resistant, medical packaging.

### SUMMARY

According to the present disclosure, a vial comprises a vial body, a lip, and at least one closure retainer. The vial body includes a side wall and a floor. An upper end of the side wall forms a mouth of the vial. The floor is coupled to a lower end of the side wall and cooperates with the side wall to define a product-storage chamber

The lip extends radially out from the side wall relative to an axis of rotation. The lip extends axially along the side wall from the mouth towards the lower end of the side wall. A lower edge of the lip forms a lip flange. The at least one closure retainer is coupled to the lip flange.

The at least one closure retainer includes an and attachment member, a ramp member, and a stop member. The attachment member is coupled to and extends radially away from the lip flange. The ramp member is coupled to and extends axially away from the attachment member towards the floor of the vial, parallel to the side wall. The stop member is coupled to and extends axially away from the attachment member towards the floor of the vial, perpendicular to the side wall.

The ramp member is offset from the side wall. A radially outer surface of the side wall, a radially inner surface of the ramp member, and a radially extending surface of the attachment member define a space between the ramp member and the side wall to decrease cooling time of the vial and cause a cycle time of the vial during manufacturing to decrease.

In illustrative embodiments, the vial comprises a plurality of closure retainers coupled to the lip flange. The plurality of closure retainers are circumferentially spaced apart from one another around the vial.

In illustrative embodiments, the ramp member extends axially along the side wall closer towards the lower edge of the side wall than the lip flange. The ramp member includes a radially extending ramp surface that engages a closure as the closure is rotated in an installation direction towards an installed position. The ramp member is coupled to the attachment member at a radially outer portion of the attachment member.

In illustrative embodiments, the stop member is coupled to the attachment member at a circumferential end of the attachment member. The stop member is coupled to the side wall.

In illustrative embodiments, the ramp member and the stop member are circumferentially spaced apart to define a closer-retainer gap.

In illustrative embodiments, the attachment member includes a closure-retainer surface on a radially extending surface of the attachment member. The closure-retaining surface extends between the ramp member and the stop member to engage a closure in an installed position. The closure-retainer surface is offset from a radially extending ramp surface of the ramp member such that a lower end of the ramp surface is located further away from the mouth of the vial than the closure-retainer surface

In illustrative embodiments, the stop member is configured to engage a closure in an installed position to block rotation of the closure in an installation direction.

In illustrative embodiments, the lip includes a plurality of projections extending radially outward from the lip. The plurality of projections are circumferentially spaced apart from each other around the lip. The plurality of projections are shaped to define recesses between each of the plurality of projections to decrease cooling time of the vial.

In another embodiment, a child-resistant package comprises a vial and a closure. The vial includes a side wall and a floor. The side wall forms a mouth of the vial. The floor is coupled to a lower end of the side wall and cooperates with the side wall to define a product-storage chamber.

The side wall includes a lip and a plurality of closure retainers. The lip extends radially out from the side wall relative to an axis of rotation and axially along the side wall from the mouth towards the lower end of the side wall. The plurality of closure retainers are coupled to a lower edge of the lip. Each one of the plurality of closure retainers include an attachment member, a ramp member, and a stop member. The attachment member is coupled to and extends radially away from the lip. The ramp member is coupled to and extends axially away from the attachment member towards the floor of the vial. The stop member is coupled to and extends axially away from the attachment member towards the floor of the vial.

The closure includes a top wall, a side wall, and a plurality of closure anchors. The side wall is arranged to extend downwardly away from an outer perimeter of the top wall. The plurality of closure anchors are coupled to an inside surface of the side wall and spaced circumferentially from one another about the axis of rotation.

The closure is configured to mount on the vial to assume an installed position closing the mouth of the vial when rotated relative to the vial about the axis of rotation in an installation direction until each of the plurality of closure retainers overlies a corresponding closure anchor to block separation of the closure from the vial along the axis of rotation.

The ramp member of a corresponding one of the plurality of closure retainers is offset from the side wall of the vial. A radially outer surface of the side wall, a radially inner surface of the ramp member, and a radially extending surface of the attachment member define a space between the ramp member and the side wall to decrease cooling time of the vial, causing cycle time of the vial during manufacturing to decrease.

In illustrative embodiments, the ramp member includes a radially extending ramp surface that engages the corresponding closure anchor as the closure is rotated in the installation direction towards the installed position. The attachment member includes a closure-retainer surface on a radially extending surface of the attachment member extending between the ramp member and the stop member that engages the corresponding closure anchor in the installed position.

In illustrative embodiments, the lip includes a plurality of projections extending radially outward from the lip. The plurality of projections are shaped to define spaces between each of the plurality of projections to decrease cooling time of the vial.

In another embodiment, a vial comprises a vial body, a lip, and at least one closure retainer. The vial body includes a side wall and a floor. An upper end of the side wall forms a mouth of the vial. The floor is coupled to a lower end of the side wall and cooperates with the side wall.

The lip extends radially out from the side wall relative to an axis of rotation and extends axially along the side wall from the mouth towards the lower end of the side wall. A lower edge of the lip forms a lip flange.

The at least one closure retainer is coupled to the lip flange. The at least one closure retainer includes an attachment member and a ramp member. The attachment member is coupled to and extends radially away from the lip flange. The ramp member is coupled to and extends axially away from the attachment member towards the floor of the vial and parallel to the side wall.

The ramp member is offset from the side wall. A radially outer surface of the side wall, a radially inner surface of the ramp member, and a radially extending surface of the attachment member define a space between the ramp member and the side wall.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a child-resistant package in accordance with the present disclosure showing a vial and a closure configured to mount on the vial to cover a mouth opening into an interior region formed in the vial, the vial including a side wall with a lip extending around the mouth of the vial;

FIG. 2 is a detail view of a portion of the vial of FIG. 1, showing the vial includes a closure retainer coupled to the lip and having an attachment member, a ramp member, and a stop member, the attachment member extending radially outward from the lip and the ramp member extending axially away from a radially outer portion of the attachment member such that a space is defined radially between the side wall and the ramp member;

FIG. 3 is a perspective view of the child-resistant package of FIG. 1, showing the closure in the installed position, mounted on the vial;

FIG. 4 is a perspective view of the child-resistant package of FIG. 1, showing the closure includes closure anchors configured to engage with the closure retainers on the vial when the closure is mounted on the vial and rotated into an installation direction;

FIG. 5 is a perspective view of the vial of FIG. 1, showing the closure retainers circumferentially spaced around the vial, and showing the lip includes projections shape to define a plurality of recesses circumferentially spaced around the lip;

FIG. 6 is a front view of a portion of the vial of FIG. 1, showing the attachment member, ramp member, and stop member of a closure retainer, the ramp member and the stop member circumferentially spaced apart by the attachment member to form a closure-retainer gap configured to receive a corresponding closure anchor;

FIG. 7 is a bottom perspective view of a portion of the vial of FIG. 1, showing a bottom surface of the attachment member, an inner surface of the ramp member, and an outer surface of the side wall of the vial defining the space between the ramp member and the side wall;

FIG. 8 is a detail view of one of the closure retainers of the vial of FIG. 1, showing the space between the ramp member and the side wall and the closure-retainer gap defined by the attachment member, the ramp member, and the stop member;

FIG. 9 is a detail view of one of the closure retainers of the vial of FIG. 1, showing another view of the space between the ramp member and the side wall and the closure-retainer gap defined by the attachment member, the ramp member, and the stop member from below;

FIG. 10 is a detail view of a portion of the vial of FIG. 1, further showing the space between the ramp member and the side wall and the closure-retainer gap defined by the attachment member, the ramp member, and the stop member;

FIG. 11 is a section view taken along section line 11-11 of FIG. 5, showing the space between the ramp member defined by the attachment member, the ramp member, and the stop member, and showing the projections and recesses of the lip;

FIG. 12 is a section view taken along section line 12-12 of FIG. 5, showing the space between the ramp member defined by the attachment member, the ramp member, and the stop member, and showing the projections and recesses of the lip;

FIGS. 13A-13B show a comparative vial design lacking an attachment member that defines a radial space between the closure retainer and a side wall of the vial and a thermal image of the comparative design showing the temperature of the vial after 11.9 seconds;

FIGS. 14A-14B show a vial with the attachment member that defines a radial space between the closure retainer and the side wall of the vial and a thermal image of the vial showing the temperature of the vial after 11.9 seconds;

FIGS. 15-65 are a series of views showing ornamental designs in accordance with the present disclosure;

FIG. 15 is a perspective view of a first embodiment of a vial, with dashed lines illustrating portions of the vial forming no part of the claimed design;

FIG. 16 is a front view of the vial of FIG. 15;

FIG. 17 is a rear view of the vial of FIG. 15;

FIG. 18 is a right side view of the vial of FIG. 15;

FIG. 19 is a left side view of the vial of FIG. 15;

FIG. 20 is a top view of the vial of FIG. 15;

FIG. 21 is a bottom view of the vial of FIG. 15;

FIG. 22 is a perspective view of the vial of FIG. 15;

FIG. 23 is an enlarged view of a portion of the vial of FIG. 22;

FIG. 24 is a cross section taken along line 24-24 in FIG. 15;

FIG. 25 is a cross section taken along line 25-25 in FIG. 15;

FIG. 26 is a perspective view of a second embodiment of a vial, with dashed lines illustrating portions of the vial forming no part of the claimed design;

FIG. 27 is a front view of the vial of FIG. 26;

FIG. 28 is a rear view of the vial of FIG. 26;

FIG. 29 is a right side view of the vial of FIG. 26;

FIG. 30 is a left side view of the vial of FIG. 26;

FIG. 31 is a top view of the vial of FIG. 26;

FIG. 32 is a bottom view of the vial of FIG. 26;

FIG. 33 is a perspective view of the vial of FIG. 26;

FIG. 34 is an enlarged view of a portion of the vial of FIG. 33;

FIG. 35 is a cross section taken along line 35-35 in FIG. 26;

FIG. 36 is a cross section taken along line 36-36 in FIG. 26;

FIG. 37 is a perspective view of a third embodiment of a vial, with dashed lines illustrating portions of the vial forming no part of the claimed design;

FIG. 38 is a front view of the vial of FIG. 37;

FIG. 39 is a rear view of the vial of FIG. 37;

FIG. 40 is a right side view of the vial of FIG. 37;

FIG. 41 is a left side view of the vial of FIG. 37;

FIG. 42 is an enlarged view of a portion of the vial of FIG. 37;

FIG. 43 is a top view of the vial of FIG. 37;

FIG. 44 is a bottom view of the vial of FIG. 37;

FIG. 45 is a cross section taken along line 45-45 in FIG. 37;

FIG. 46 is a perspective view of a fourth embodiment of a vial, with dashed lines illustrating portions of the vial forming no part of the claimed design;

FIG. 47 is a front view of the vial of FIG. 46;

FIG. 48 is a rear view of the vial of FIG. 46;

FIG. 49 is a right side view of the vial of FIG. 46;

FIG. 50 is a left side view of the vial of FIG. 46;

FIG. 51 is an enlarged view of a portion of the vial of FIG. 46;

FIG. 52 is a top view of the vial of FIG. 46;

FIG. 53 is a bottom view of the vial of FIG. 46;

FIG. 54 is a cross section taken along line 54-54 in FIG. 46;

FIG. 55 is a perspective view of a fifth embodiment of a vial, with dashed lines illustrating portions of the vial forming no part of the claimed design;

FIG. 56 is a front view of the vial of FIG. 55;

FIG. 57 is a rear view of the vial of FIG. 55;

FIG. 58 is a right side view of the vial of FIG. 55;

FIG. 59 is a left side view of the vial of FIG. 55;

FIG. 60 is a top view of the vial of FIG. 55;

FIG. 61 is a bottom view of the vial of FIG. 55;

FIG. 62 is a perspective view of the vial of FIG. 55;

FIG. 63 is an enlarged view of a portion of the vial of FIG. 62;

FIG. 64 is a cross section taken along line 64-64 in FIG. 55;

FIG. 65 is a cross section taken along line 65-65 in FIG. 55;

FIG. 66 is a perspective view of a child-resistant package in accordance with the present disclosure showing a vial and a closure configured to mount on the vial to cover a mouth opening into an interior region formed in the vial, the vial including a side wall with a lip extending around the mouth of the vial;

FIG. 67 is a detail view of a portion of the vial of FIG. 66, showing the vial includes a closure retainer coupled to the lip and having an attachment member, a ramp member, and a stop member, the attachment member extending radially outward from the lip and the ramp member extending axially away from a radially outer portion of the attachment member such that a space is defined radially between the side wall and the ramp member;

FIG. 68 is a perspective view of the child-resistant package of FIG. 66, showing the closure in the installed position, mounted on the vial;

FIG. 69 is a perspective view of the child-resistant package of FIG. 66, showing the closure includes closure anchors configured to engage with the closure retainers on the vial when the closure is mounted on the vial and rotated into an installation direction;

FIG. 70 is a perspective view of the vial of FIG. 66, showing the closure retainers circumferentially spaced around the vial, and showing the lip includes projections shape to define a plurality of recesses circumferentially spaced around the lip;

FIG. 71 is a front view of a portion of the vial of FIG. 66, showing the attachment member, ramp member, and stop member of a closure retainer, the ramp member and the stop member circumferentially spaced apart by the attachment member to form a closure-retainer gap configured to receive a corresponding closure anchor;

FIG. 72 is a bottom perspective view of a portion of the vial of FIG. 66, showing a bottom surface of the attachment member, an inner surface of the ramp member, and an outer surface of the side wall of the vial defining the space between the ramp member and the side wall;

FIG. 73 is a detail view of one of the closure retainers of the vial of FIG. 66, showing the space between the ramp member and the side wall and the closure-retainer gap defined by the attachment member, the ramp member, and the stop member;

FIG. 74 is a detail view of one of the closure retainers of the vial of FIG. 66, showing another view of the space between the ramp member and the side wall and the closure-retainer gap defined by the attachment member, the ramp member, and the stop member from below;

FIG. 75 is a detail view of a portion of the vial of FIG. 66, further showing the space between the ramp member and the side wall and the closure-retainer gap defined by the attachment member, the ramp member, and the stop member;

FIG. 76 is a section view taken along section line 76-76 of FIG. 70, showing the space between the ramp member defined by the attachment member, the ramp member, and the stop member, and showing the projections and recesses of the lip;

FIG. 77 is a section view taken along section line 77-77 of FIG. 70, showing the space between the ramp member defined by the attachment member, the ramp member, and the stop member, and showing the projections and recesses of the lip;

FIGS. 78A-78B show a comparative vial design lacking an attachment member that defines a radial space between the closure retainer and a side wall of the vial and a thermal image of the comparative design showing the temperature of the vial after 11.9 seconds;

FIGS. 79A-79B show a vial with the attachment member that defines a radial space between the closure retainer and the side wall of the vial and a thermal image of the vial showing the temperature of the vial after 11.9 seconds; and

FIGS. 80-130 are a series of views showing ornamental designs in accordance with the present disclosure.

FIG. 80 is a perspective view of a sixth embodiment of a vial, with dashed lines illustrating portions of the vial forming no part of the claimed design;

FIG. 81 is a front view of the vial of FIG. 80;

FIG. 82 is a rear view of the vial of FIG. 80;

FIG. 83 is a right side view of the vial of FIG. 80;

FIG. 84 is a left side view of the vial of FIG. 80;

FIG. 85 is a top view of the vial of FIG. 80;

FIG. 86 is a bottom view of the vial of FIG. 80;

FIG. 87 is a perspective view of the vial of FIG. 80;

FIG. 88 is an enlarged view of a portion of the vial of FIG. 87;

FIG. 89 is a cross section taken along line 89-89 in FIG. 80;

FIG. 90 is a cross section taken along line 90-90 in FIG. 80;

FIG. 91 is a perspective view of a seventh embodiment of a vial, with dashed lines illustrating portions of the vial forming no part of the claimed design;

FIG. 92 is a front view of the vial of FIG. 91;

FIG. 93 is a rear view of the vial of FIG. 91;

FIG. 94 is a right side view of the vial of FIG. 91;

FIG. 95 is a left side view of the vial of FIG. 91;

FIG. 96 is a top view of the vial of FIG. 91;

FIG. 97 is a bottom view of the vial of FIG. 91;

FIG. 98 is a perspective view of the vial of FIG. 91;

FIG. 99 is an enlarged view of a portion of the vial of FIG. 98;

FIG. 100 is a cross section taken along line 100-100 in FIG. 91;

FIG. 101 is a cross section taken along line 101-101 in FIG. 91;

FIG. 102 is a perspective view of an eighth embodiment of a vial, with dashed lines illustrating portions of the vial forming no part of the claimed design;

FIG. 103 is a front view of the vial of FIG. 102;

FIG. 104 is a rear view of the vial of FIG. 102;

FIG. 105 is a right side view of the vial of FIG. 102;

FIG. 106 is a left side view of the vial of FIG. 102;

FIG. 107 is an enlarged view of a portion of the vial of FIG. 102;

FIG. 108 is a top view of the vial of FIG. 102;

FIG. 109 is a bottom view of the vial of FIG. 102;

FIG. 110 is a cross section taken along line 110-110 in FIG. 102;

FIG. 111 is a perspective view of a ninth embodiment of a vial, with dashed lines illustrating portions of the vial forming no part of the claimed design;

FIG. 112 is a front view of the vial of FIG. 111;

FIG. 113 is a rear view of the vial of FIG. 111;

FIG. 114 is a right side view of the vial of FIG. 111;

FIG. 115 is a left side view of the vial of FIG. 111;

FIG. 116 is an enlarged view of a portion of the vial of FIG. 111;

FIG. 117 is a top view of the vial of FIG. 111;

FIG. 118 is a bottom view of the vial of FIG. 111;

FIG. 119 is a cross section taken along line 119-119 in FIG. 111;

FIG. 120 is a perspective view of a tenth embodiment of a vial, with dashed lines illustrating portions of the vial forming no part of the claimed design;

FIG. 121 is a front view of the vial of FIG. 120;

FIG. 122 is a rear view of the vial of FIG. 120;

FIG. 123 is a right side view of the vial of FIG. 120;

FIG. 124 is a left side view of the vial of FIG. 120;

FIG. 125 is a top view of the vial of FIG. 120;

FIG. 126 is a bottom view of the vial of FIG. 120;

FIG. 127 is a perspective view of the vial of FIG. 120;

FIG. 128 is an enlarged view of a portion of the vial of FIG. 127;

FIG. 129 is a cross section taken along line 129-129 in FIG. 120; and

FIG. 130 is a cross section taken along line 130-130 in FIG. 120.

### DETAILED DESCRIPTION

A vial 12 comprises a vial body include a side wall 30 and a floor 32. The upper end of the side wall 32 forms a mouth 15 of the vial 12. The floor 32 is coupled to a lower end of the side wall 30 and cooperates with the side wall 30 to define a product-storage chamber. The vial 12 further includes a lip 20 extending radially out from the side wall 30 relative to an axis of rotation 17. The lip 20 extends axially along the side wall 30 from the mouth 15 towards the lower end of the side wall 30. The lower edge of the lip 20 forms a lip flange 24.

The vial 12 includes at least one closure retainer 34 coupled to the lip flange 24. The closure retainer 34 includes an attachment member 50, a ramp member 60, and a stop member 70. The attachment member 50 is coupled to the lip flange 24, coupling the closure retainer 34 to the lip flange 24. The attachment member 50 extends radially outward from the lip flange 24. The ramp member 60 is coupled to the attachment member 50 and extends out axially from the attachment member 50 towards the floor 32 of the vial 12, parallel to the side wall 30. The stop member 70 is coupled to the attachment member 50 and extends axially from the attachment member 50 towards the floor 32 of the vial 12 and perpendicular to the side wall 30.

The ramp member 60 is offset from the side wall 30 to define a space 35 disposed radially between the side wall 30 and the ramp member 60. A radially outer surface of the side wall 30, a radially inner surface 62 of the ramp member 60, and a bottom, radially extending surface 52 of the attachment member 50 define the space between the ramp member 60 and the side wall 30. The space 35 decreases the cooling time of the vial 12 and causes cycle time of the vial 12 during manufacturing to decrease.

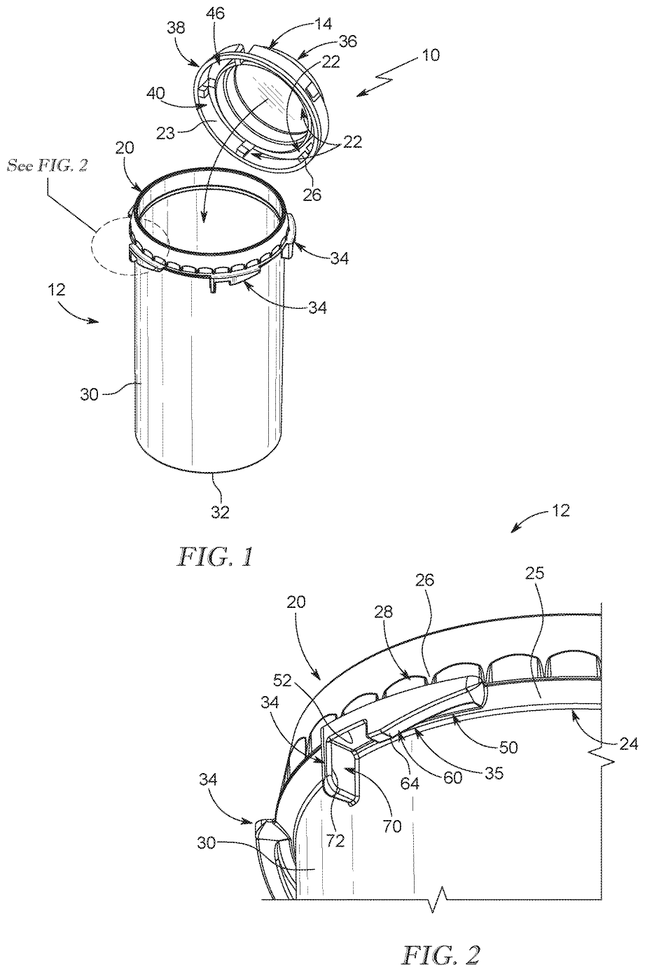

Turning to the figures, a child-resistant package 10 includes a vial 12, or container, and a closure 14 mounted on vial 12 to cover a mouth 15 opening into a product-storage chamber 16 formed in vial 12, as shown in the illustrative embodiment of FIG. 1. The vial 12 is adapted to accept the closure 14 to seal in the contents of vial 12. The product-storage chamber 16 is adapted to contain a product, such as medication, and is sealed when the closure 14 is coupled to the vial 12.

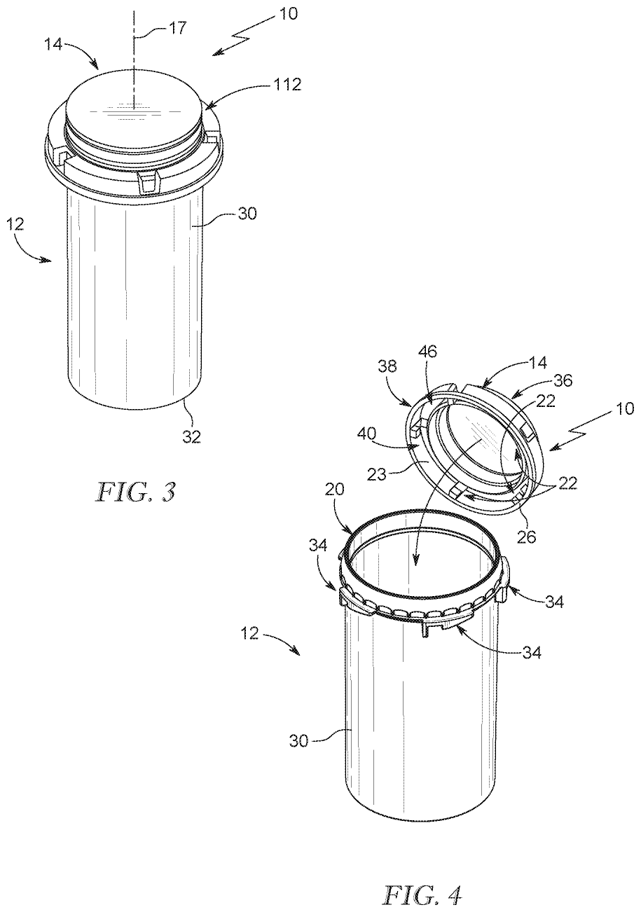

The vial 12 includes an annular sidewall 30 and a floor 32 coupled to a lower end of the side wall 30. The side wall 30 includes a lip 20 and a plurality of closure retainers 34 coupled to an outer surface of the lip 20 as shown in FIG. 2. The side wall 30 extends vertically along an axis 17 of the child-resistant package 10. The side wall 30 and the floor 32 cooperate to define the product-storage chamber 16 of vial 12. The plurality of closure retainers 34 extend outwardly away from the axis 17, or radially out from a radially outer surface of the lip 20 and are configured to cooperate with the closure 14 to retain the closure 14 on vial 12 in a full-installed position as shown in FIG. 3. The closure 14 is arranged to be coupled to the vial 12 after rotation of the closure 14 about the axis of rotation 17.

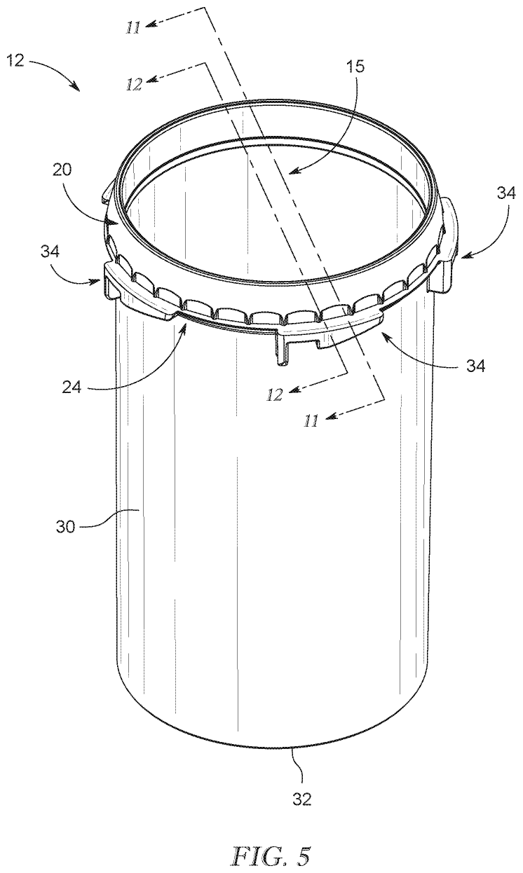

As show in FIG. 5, the lip 20 extends radially outwards from the side wall 30, away from the axis 17. The lip 20 extends axially at least partially along the outer surface of the side wall 30 from the mouth 15 towards the lower end of the side wall 30. In the illustrative embodiment, the lip 20 extends circumferentially around an entire circumference of the mouth 15 of the vial 12. In other embodiments, the lip 20 extends partially around the circumference of the vial 12. In the illustrative embodiments, the lip 20 is tapered, with a radial thickness of the lip 20 increasing in the axial direction as the lip 20 extends along the side wall 30 away from the mouth 15.

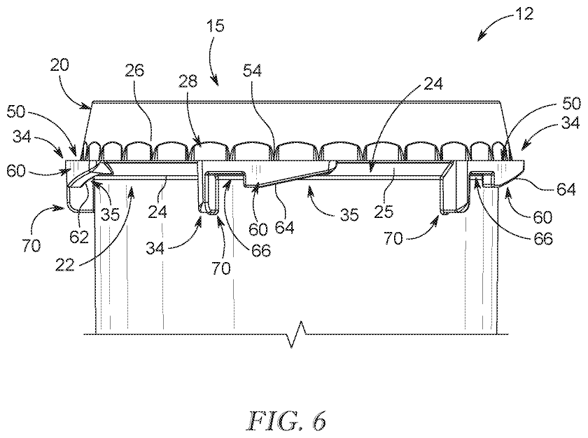

As show in FIGS. 5-6, in the illustrative embodiment, the lip 20 includes a plurality of projections 26 extending radially outward from the lip 20. In some embodiments, the lip 20 may not include projections. The projections 26 are circumferentially spaced apart from around the circumference of the lip 20 to define recesses 28 or spaces between a corresponding pair of projections 26. In the illustrative embodiments, the projections 26 and recesses 28 form a scallop pattern extending around the lip 20, where the recesses 28 each have a curved upper edge disposed opposite the radially extending surface 54 of the lip 20. In the illustrative embodiment, each of the recesses 28 extends a longer distance circumferentially around a circumference of the lip 20 than an axial distance the recesses 28 extends along the axis 17. The recesses 28 also each have a greater circumferential dimension than a circumferential dimension of a projection 26. In other words, each of the recesses 28 extends circumferentially along the lip 20 than each of the projections 26, forming relatively wide recesses 28 and narrow projections in the circumferential direction relative to the axis 17.

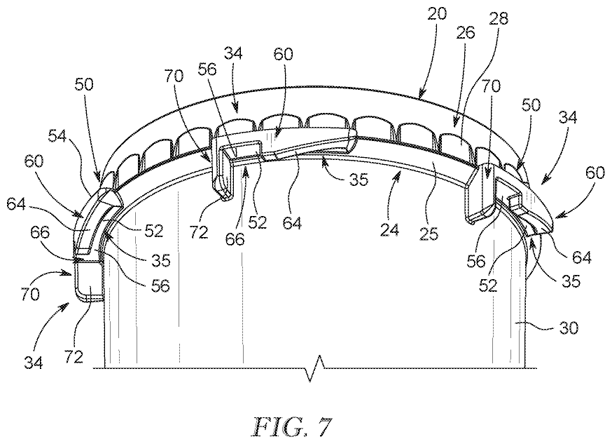

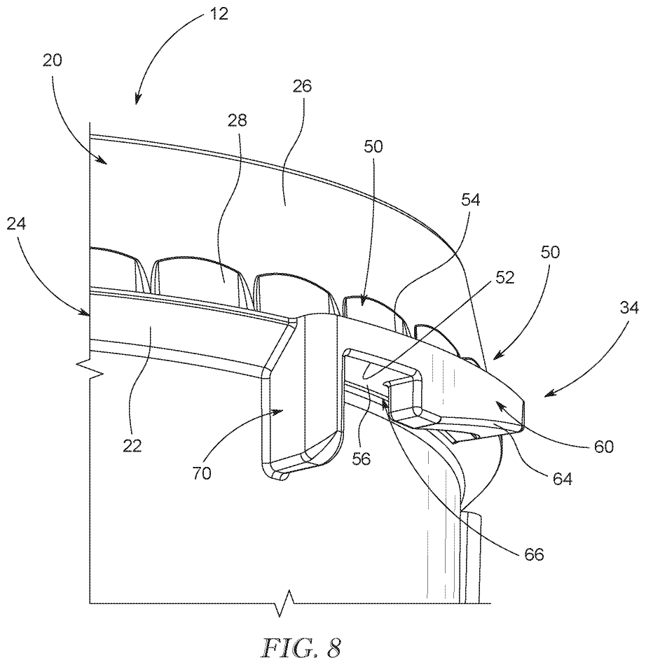

As shown in FIG. 7, a lower edge of the lip 20 forms a lip flange 24. The lip flange 24 may comprise a flange surface 25, extending from a radially-most outer portion of the lip 20 inwards to an outer surface of the sidewall 30. In the illustrative embodiment, the lip flange 24 is tapered such that the flange 25 surface extends both in the radial and axial directions relative to the axis 17. The closure retainers 34 are coupled to the flange surface 25 of the lip flange 24, extending radially outward from the flange surface 25. In the illustrative embodiment, the vial 12 comprises a plurality of closure retainers 34 circumferentially spaced apart from each other around the vial 12.

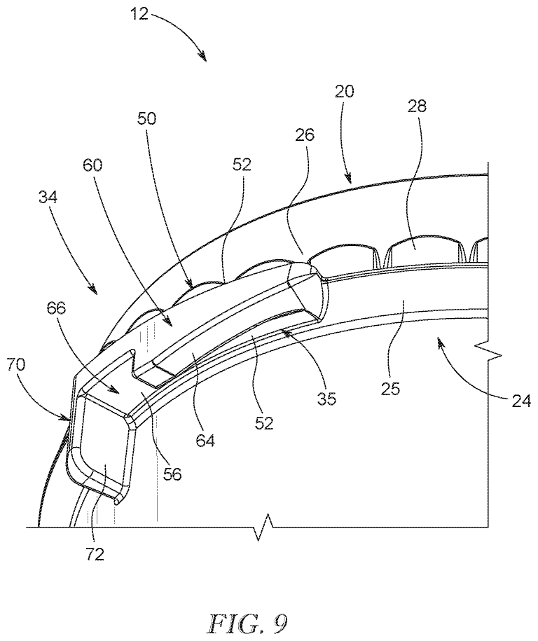

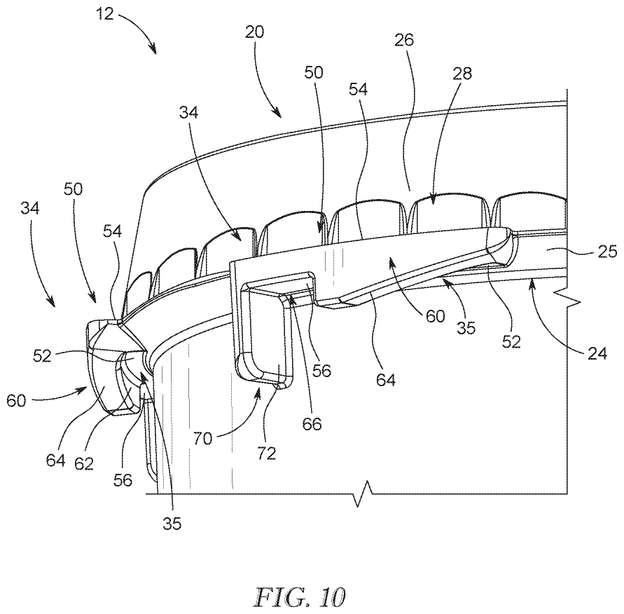

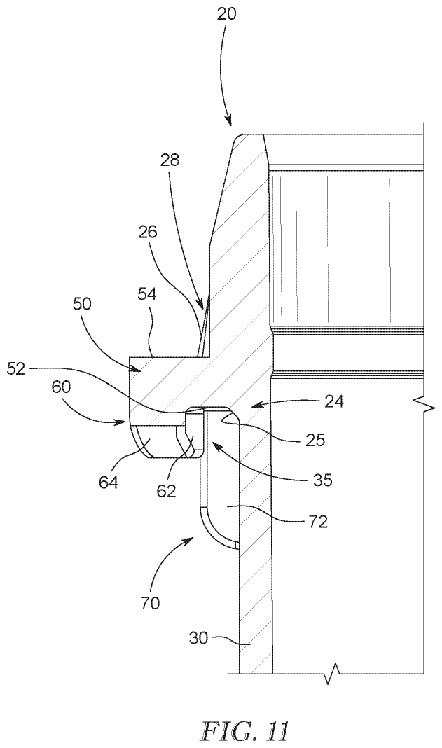

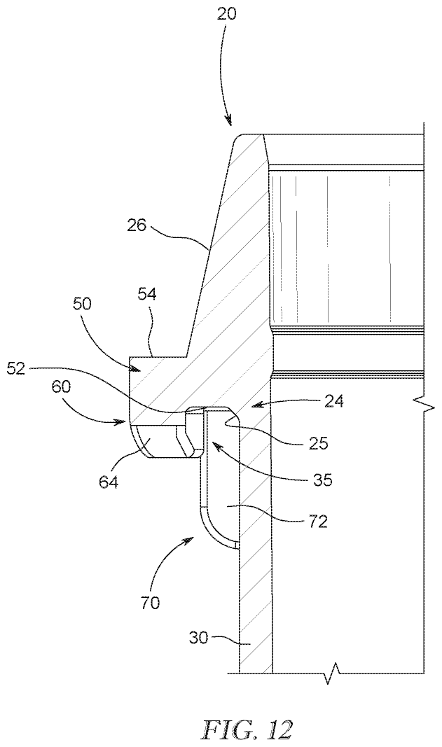

As shown in FIGS. 8-10, in the illustrative embodiment, each of the closure retainers 34 includes an attachment member 50, a ramp member 60, and a stop member 70. The attachment member 50 extends radially outward from the flange surface 25 and couples the closure retainer 34 to flange surface 25 of the lip flange 24. In the illustrative embodiment, the attachment member 50 extends circumferentially along the outer surface of the side wall 30 and extends outwards perpendicular to the side wall 30. A bottom, radially extending surface 52 of the attachment member 50 at least partially defines the space 35 between the ramp member 60 and the side wall 30. An upper, radially extending surface 54 of the attachment member 50 extends outward from the lower edge of the lip 20 at an upper end of the lip flange 24.

The ramp member 60 is coupled to a radially outer portion of the attachment member 50 and extends away from the attachment member 50 in the axial direction. The ramp member 60 extends axially away from the mouth 15 of the vial 12 and towards the floor 32. In the illustrative embodiment, the ramp member 60 extends parallel to the side wall 30, off set from the side wall 30. An inner, radially extending surface 62 of the ramp member 60 is disposed opposite from and faces the outer surface of the side wall 30. The inner surface 62 at least partially defines the space 35 between the ramp member 60 and the side wall 30, the space 35 disposed radially between the outer surface of the side wall 30 and the inner surface 62 of the ramp member 60.

The ramp member 60 includes a radially extending ramp surface 64 that forms a bottom edge of the ramp member 60, the edge of the ramp member 60 is disposed closest to the floor 32 of the vial 12 in the axial direction. The ramp surface 64 engages the closure 14 as the closure 14 is rotated in a closure-installation direction towards the installed position, shown in FIG. 3.

The stop member 70 is coupled to the attachment member 50. In the illustrative embodiment, the stop member 70 is coupled to a circumferential end portion of the attachment member 50. The stop member 70 extends axially away from the attachment member 50 towards the floor 32 of the vial 12. In the illustrative embodiment, the stop member 70 is coupled to the side wall 30 and extends perpendicular to the side wall 30. The stop member is configured to engage the closure 14 in an installed position to block rotation of the closure 14 in a closure-installation direction. An axially extending inner surface 72 of the stop member partially defines the space 35 disposed between the side wall 35 and the ramp member 60.

In the illustrative embodiment, the ramp member 60 and the stop member 70 are circumferentially spaced apart by a portion of the attachment member 50 to define a closure-retainer gap 66 disposed circumferentially between the ramp member 60 and the stop member 70. The bottom surface 52 of the stop member 70 includes a closure-retainer surface 56 that extends between the ramp member 60 and the stop member 70 in the closure-retainer gap 66. The closure-retainer surface 56 engages a corresponding closure anchor 22 in an installed position. The closure-retainer surface 56 is offset from the ramp surface 64 of the ramp member 60 such that an axially lower end of the ramp surface 64 is located further away from the mouth 15 of the vial 12 than the closure-retainer surface 56.

In some embodiments, the vial 12 is formed through molding, for example, injection molding. The space 35 defined between the surfaces of the side wall 30 and the ramp member 60 and/or the recesses 28 formed in the lip 20 of the vial 12 advantageously work to remove weight and mass from the vial 12. In some embodiments, the space 35 and/or recesses 28 reduce the weight of the vial 12 by 0.65 g. In some embodiments, the weight may be reduced by more or less than 0.65 g. This helps use less material during manufacturing of the vial 12 and allows for faster cooling of the vial 12 during molding.

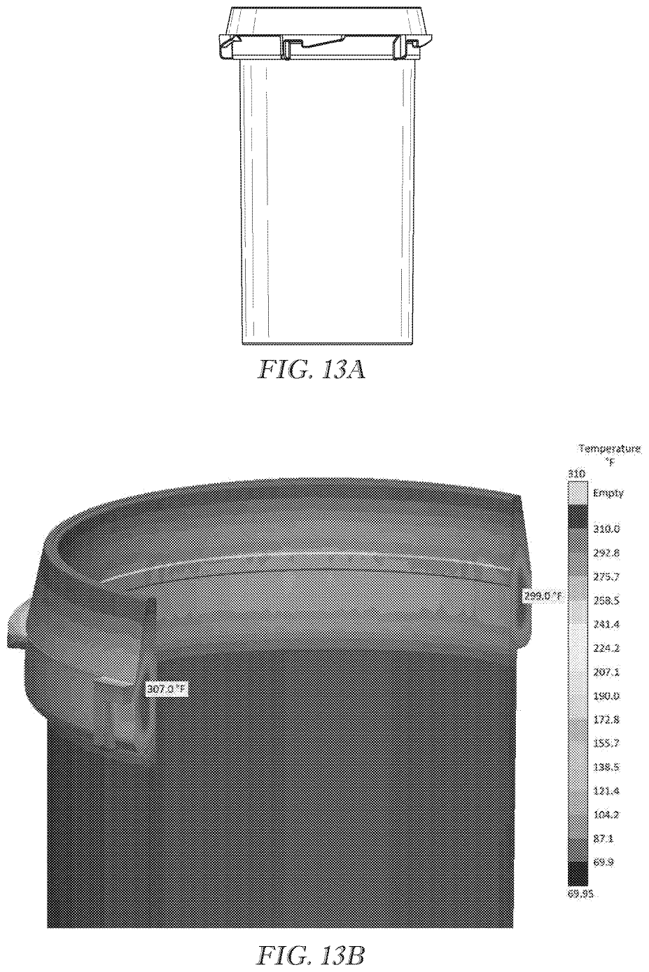

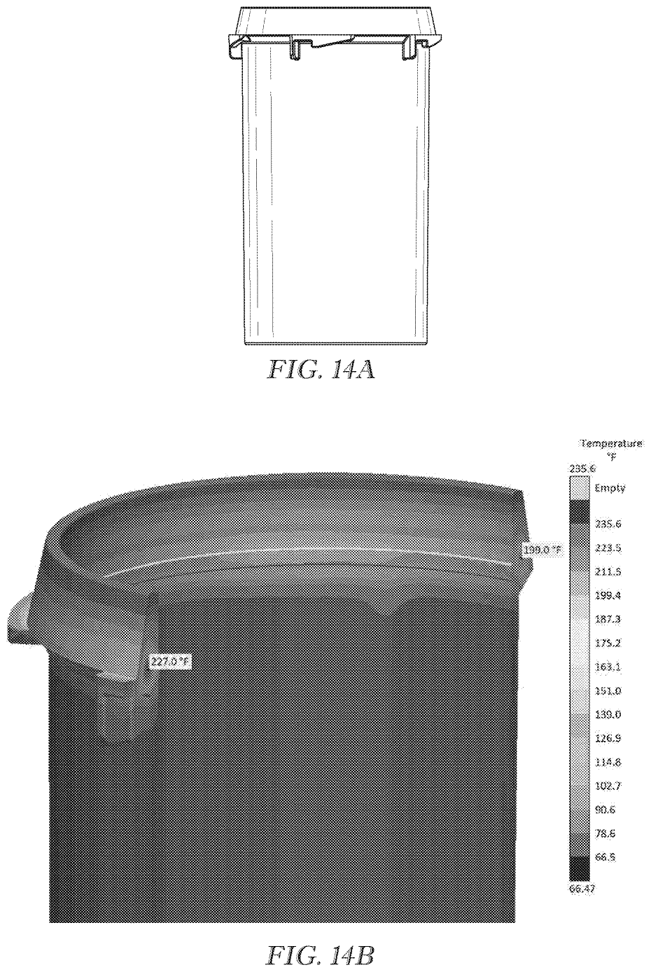

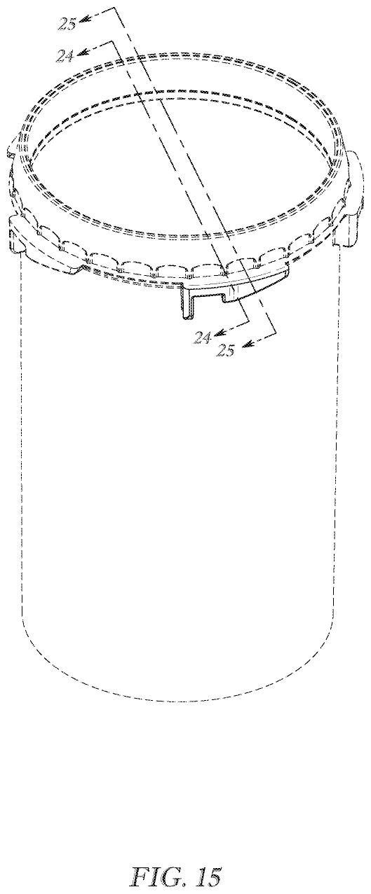

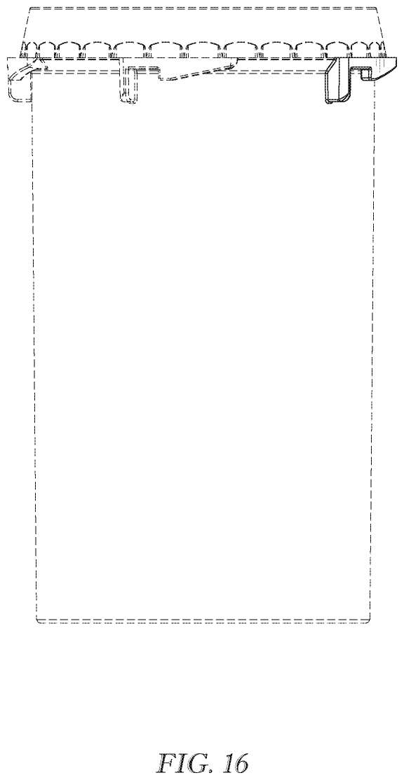

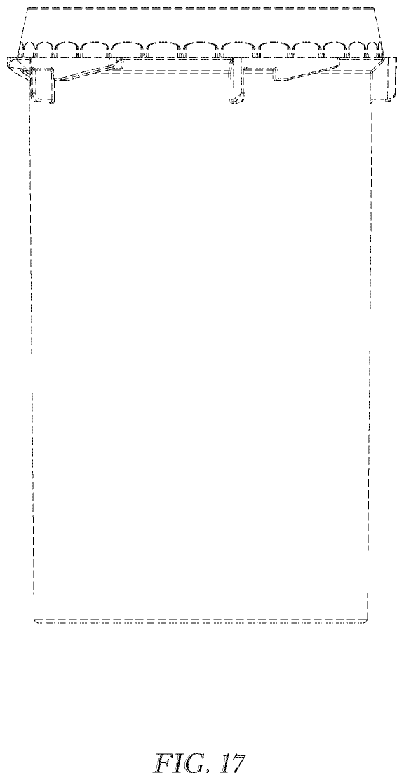

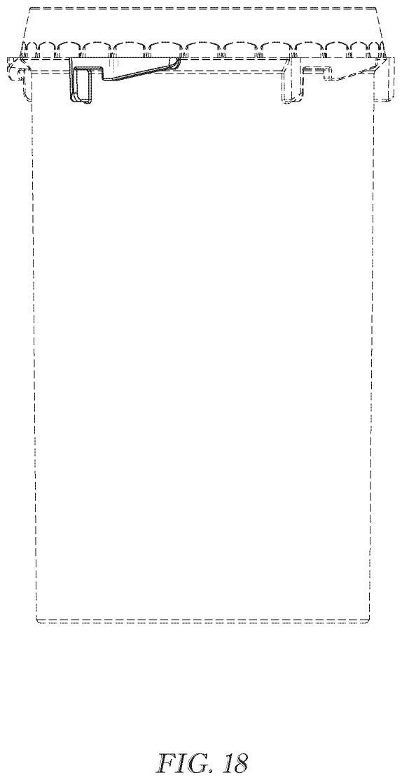

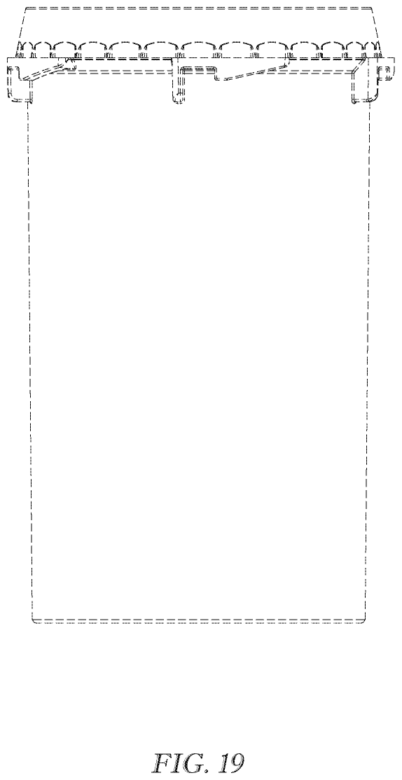

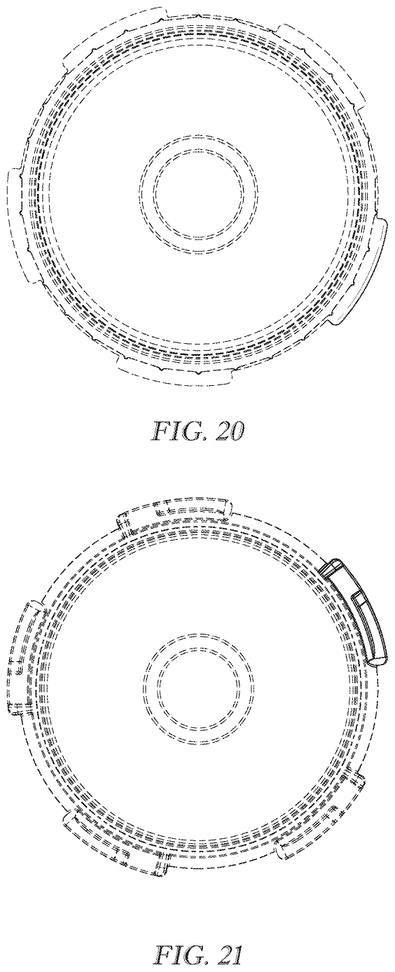

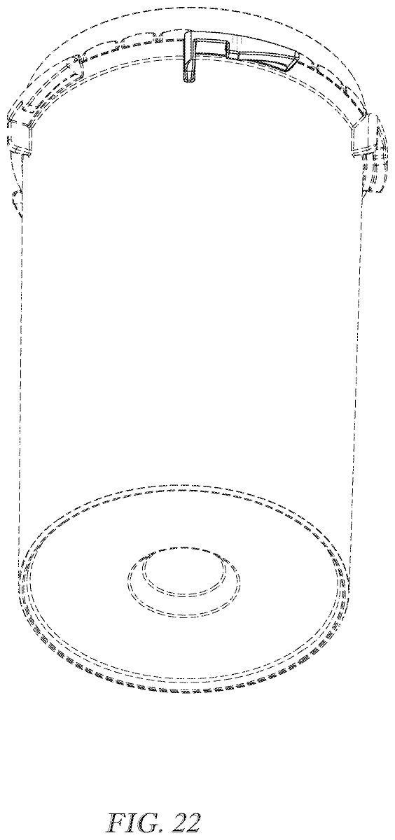

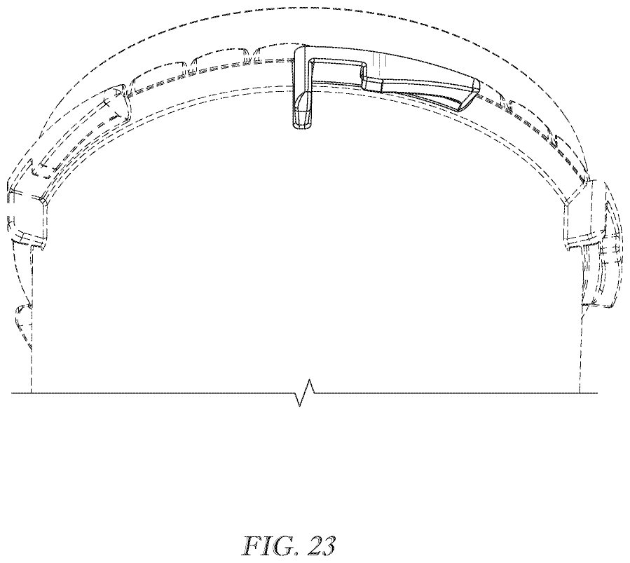

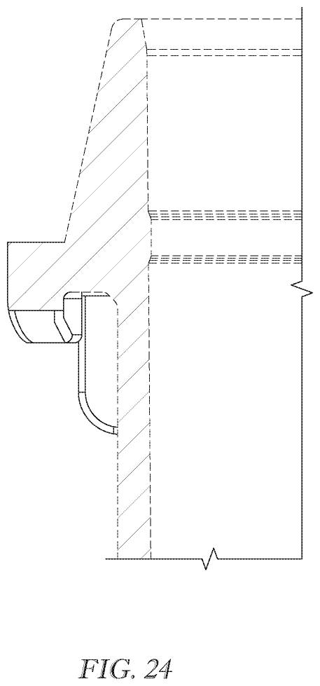

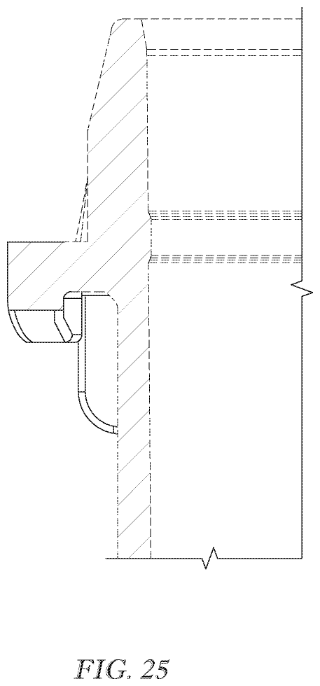

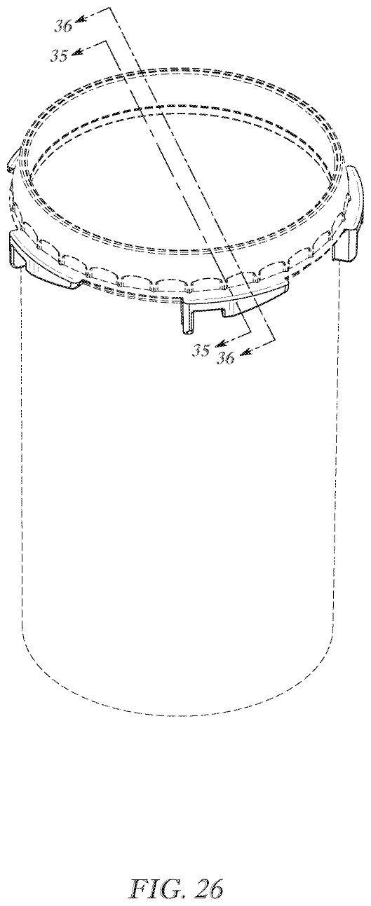

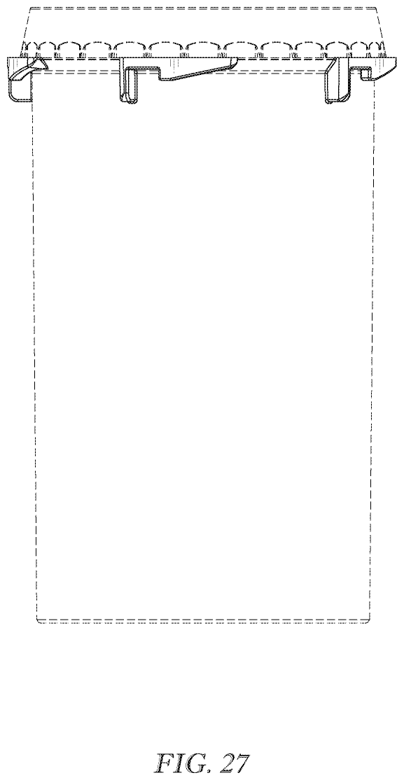

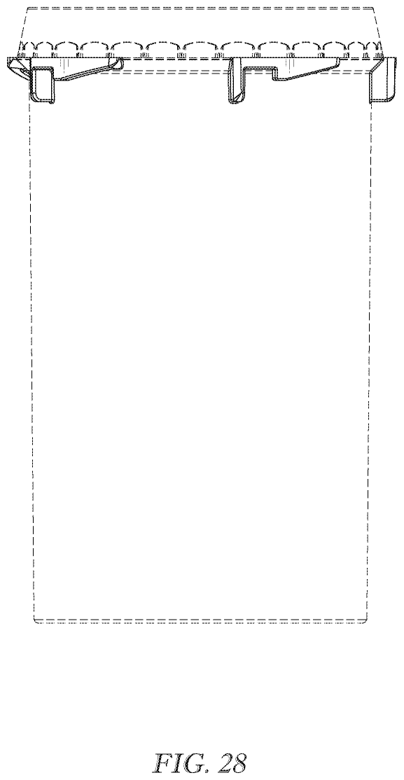

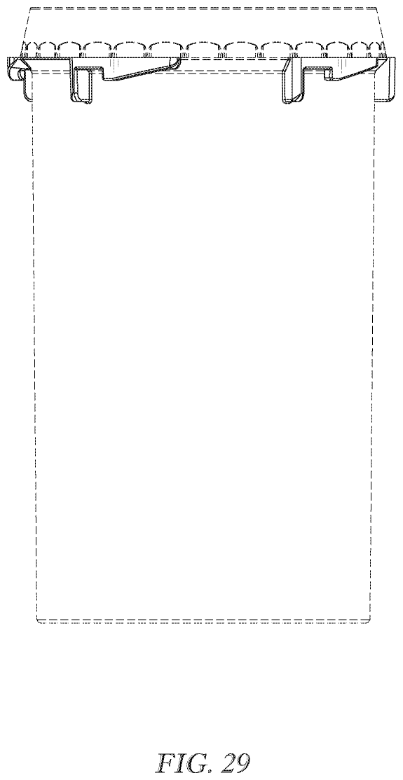

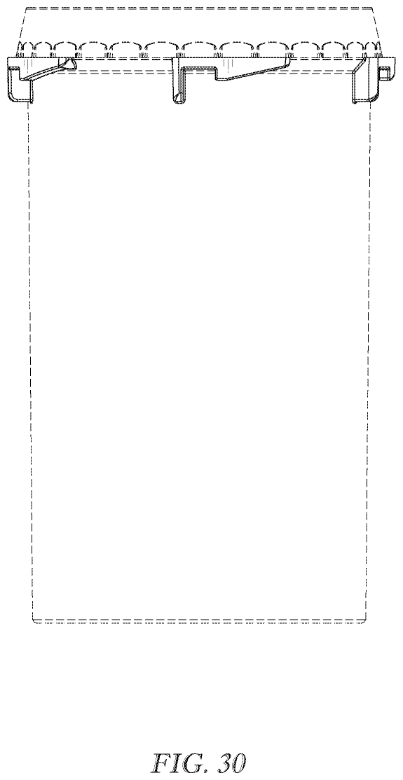

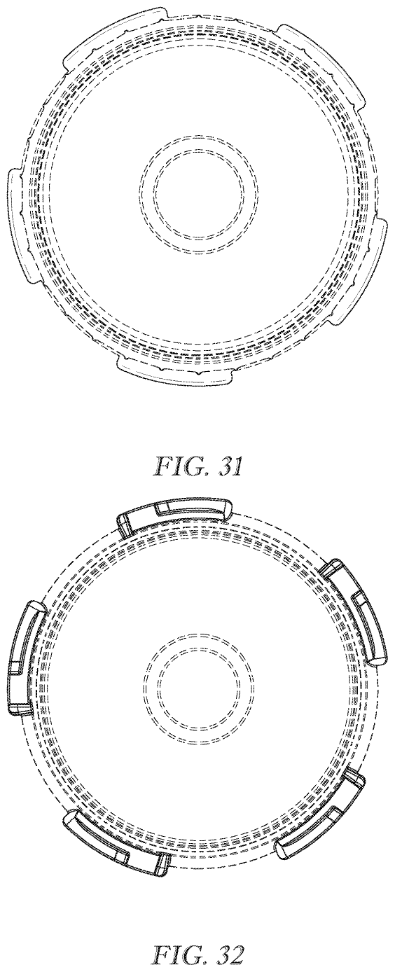

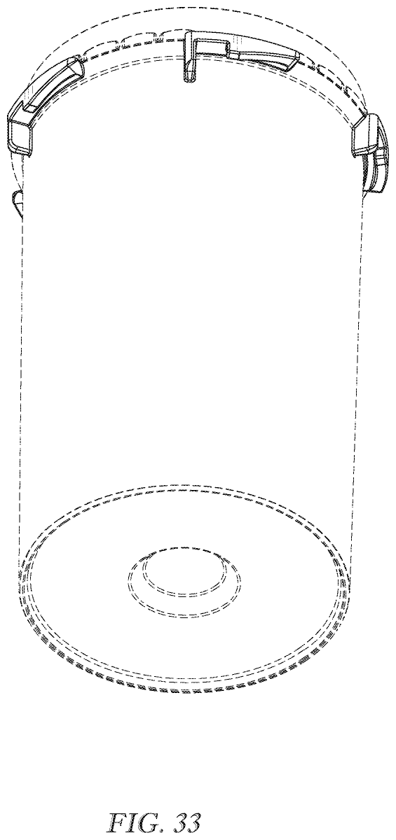

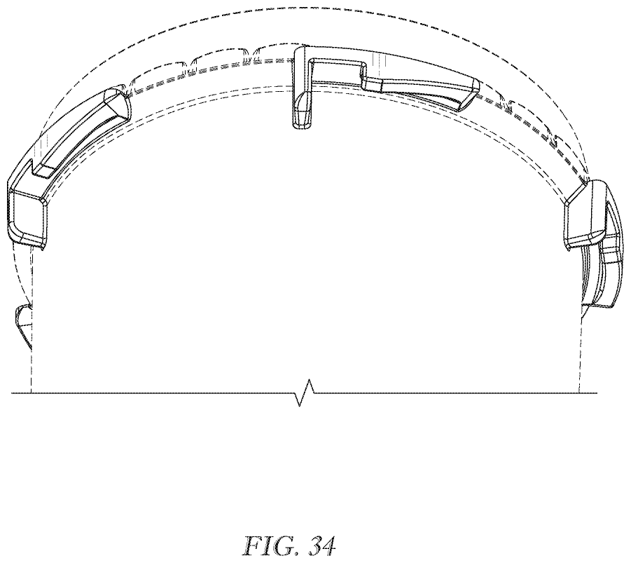

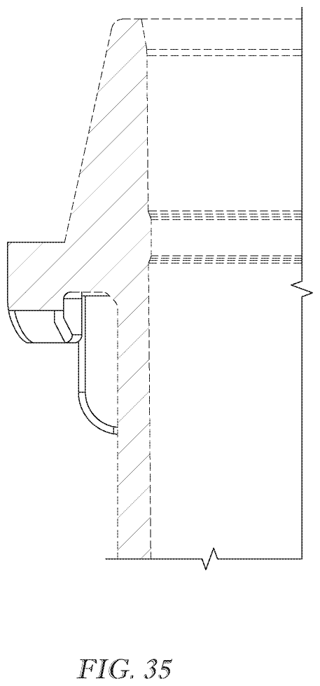

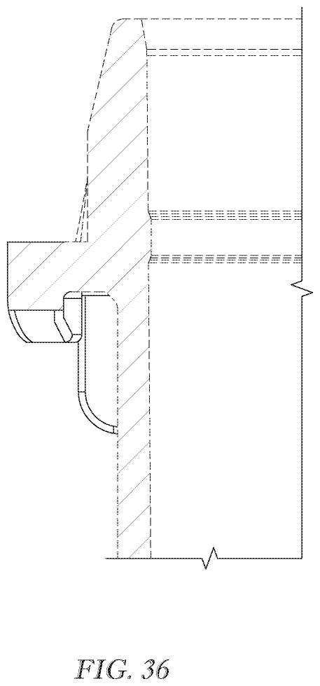

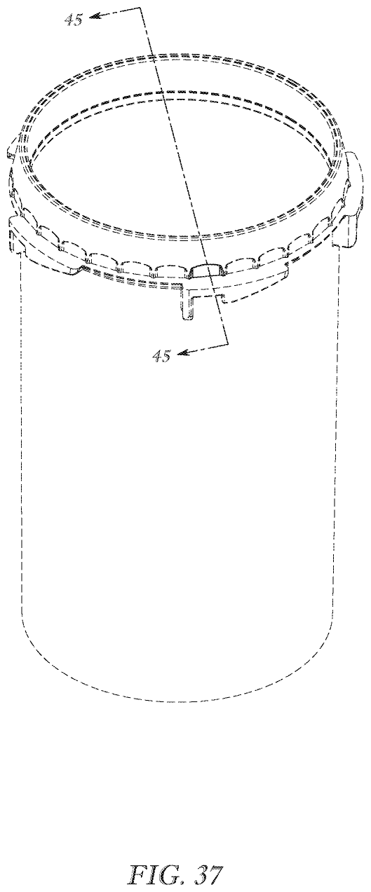

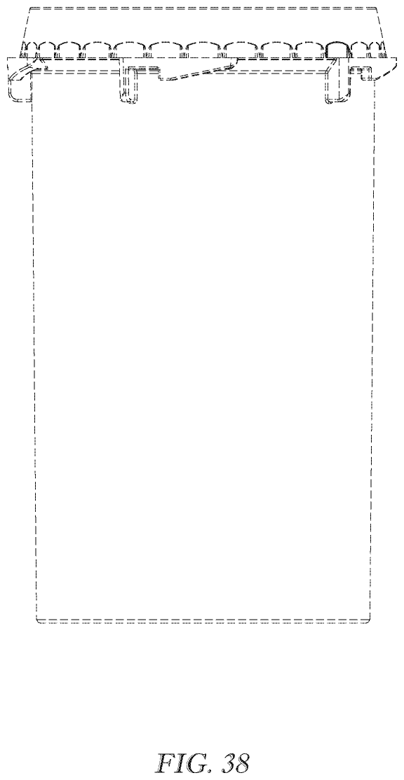

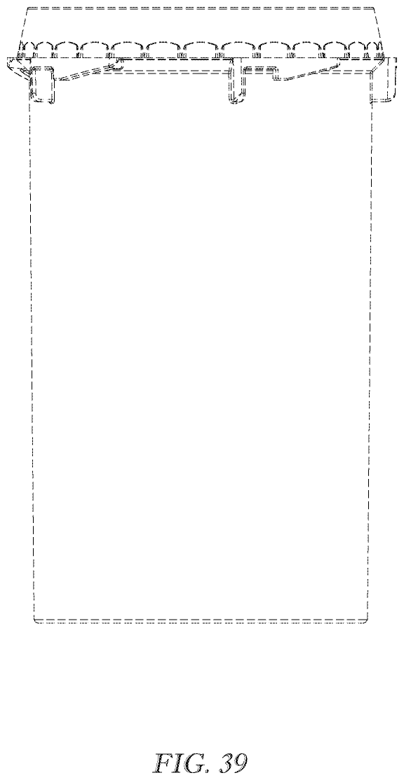

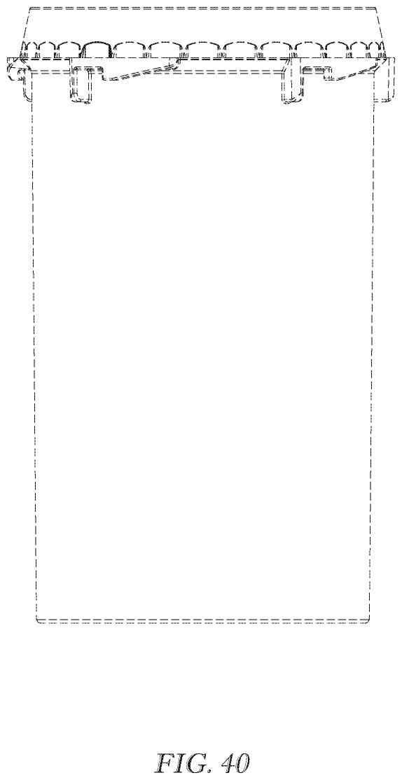

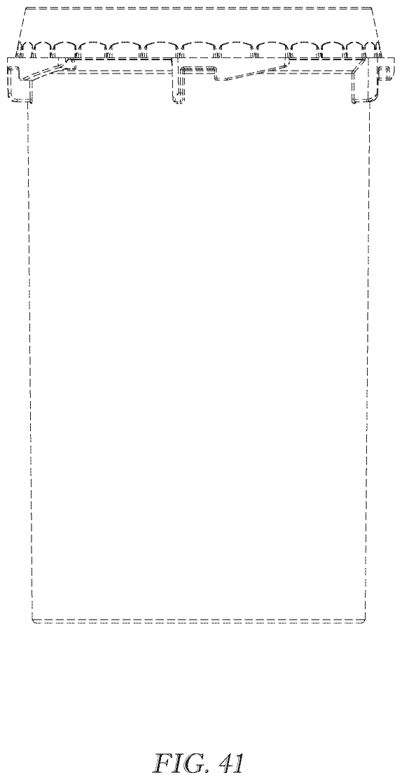

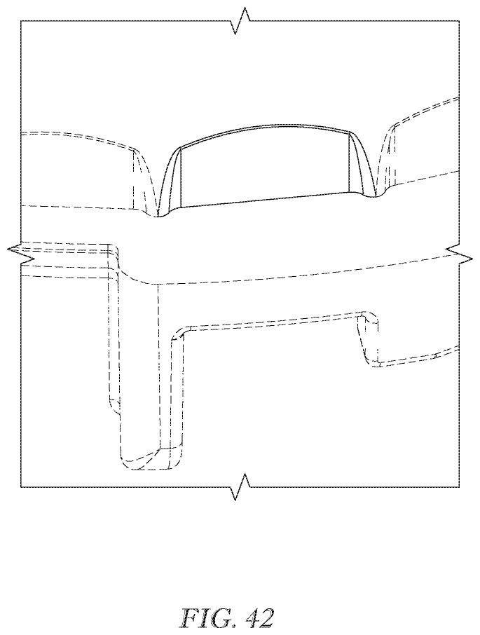

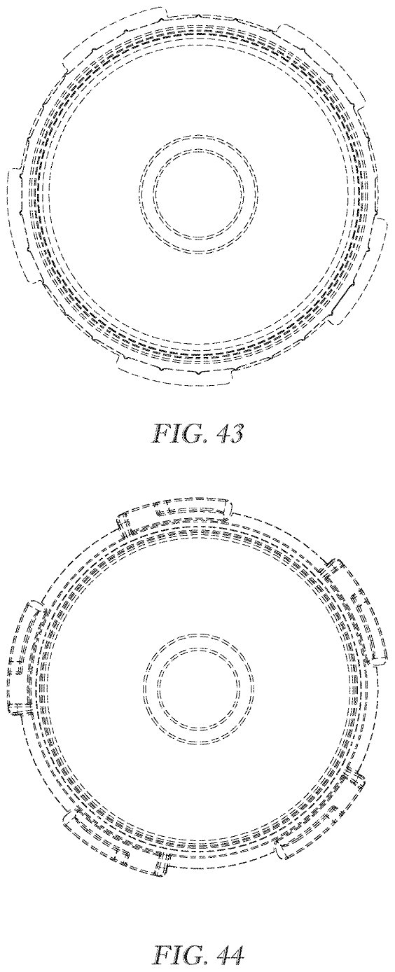

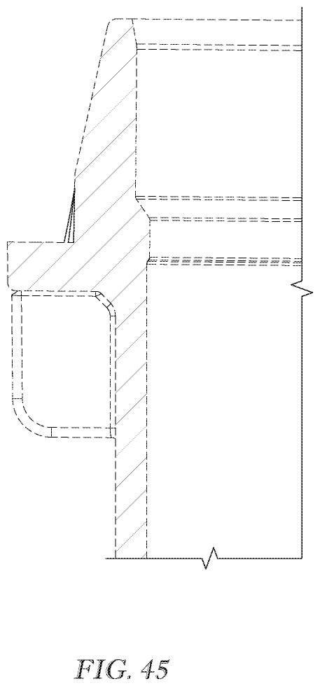

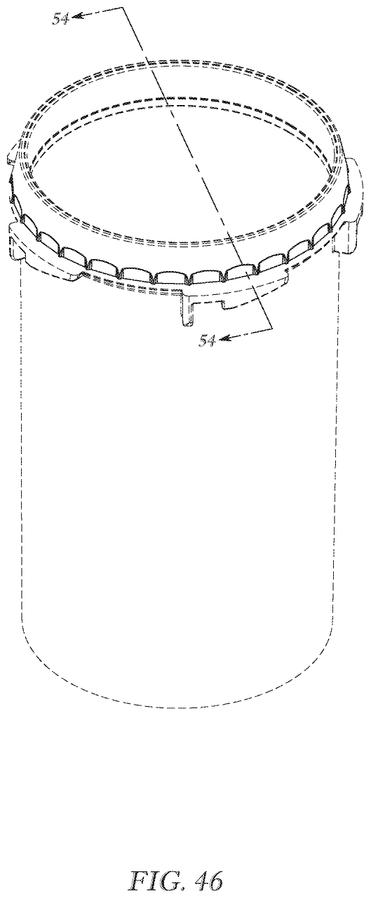

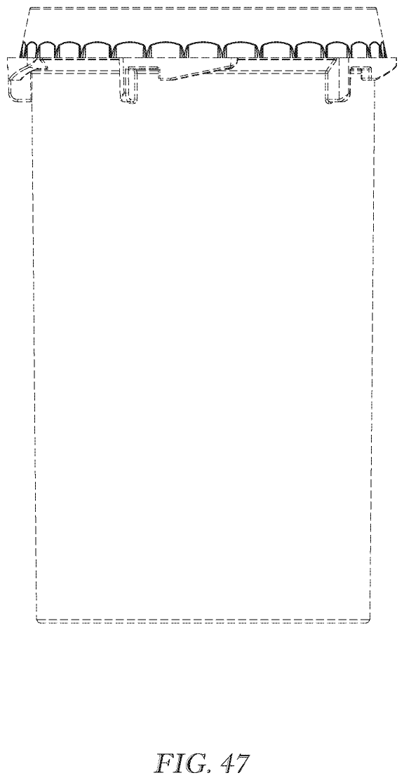

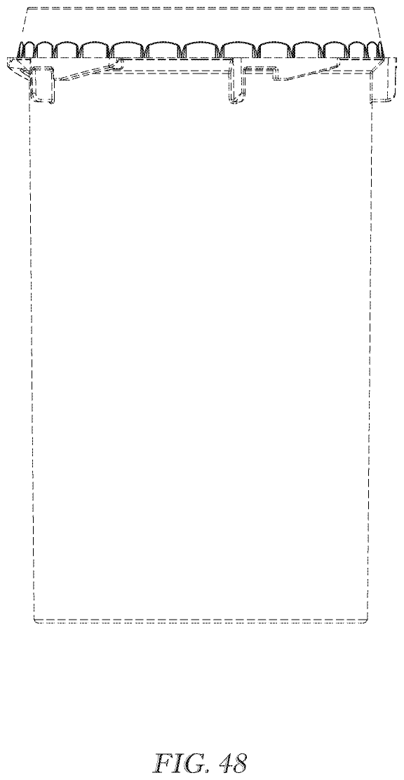

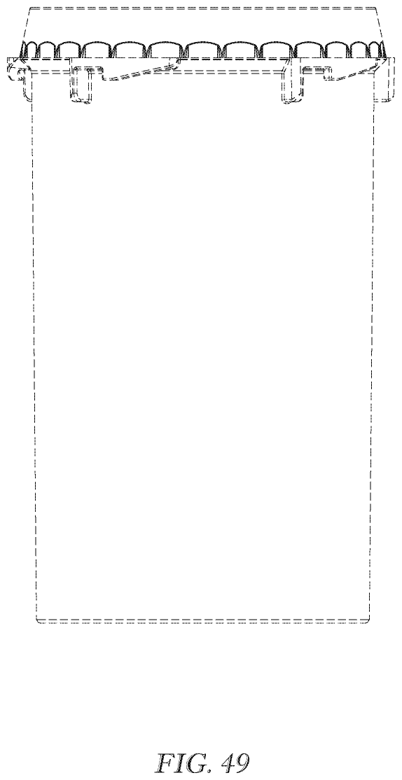

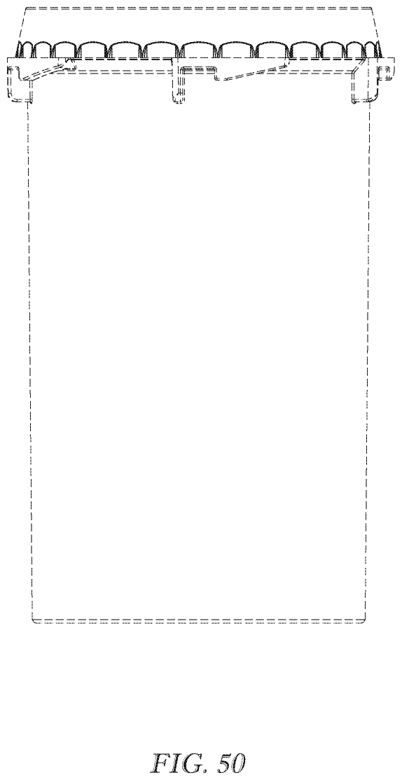

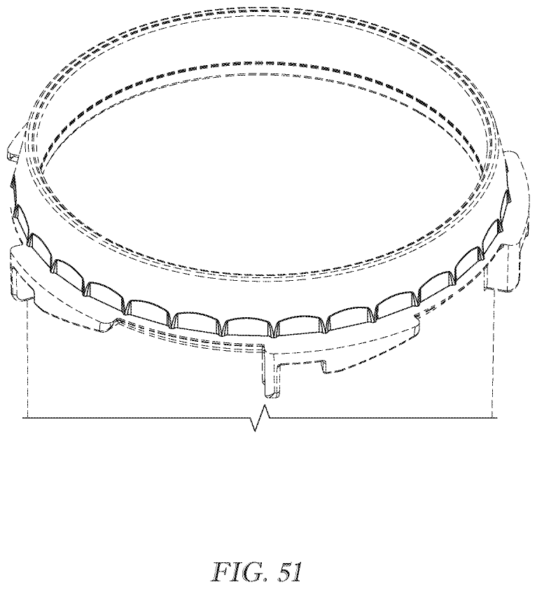

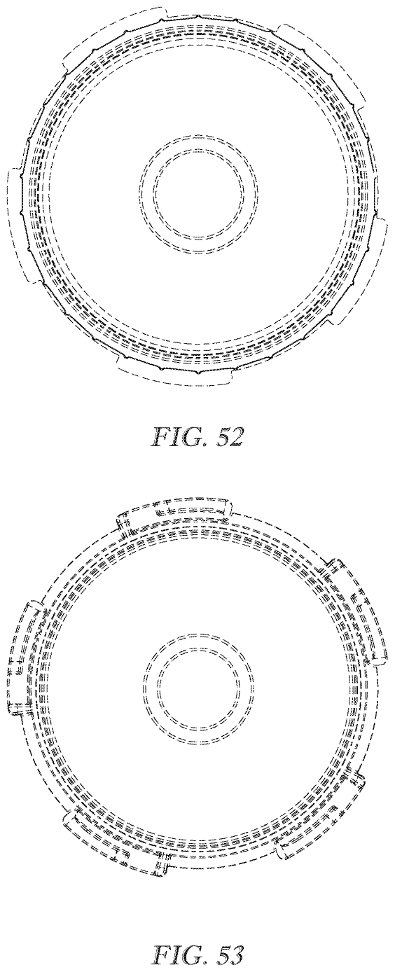

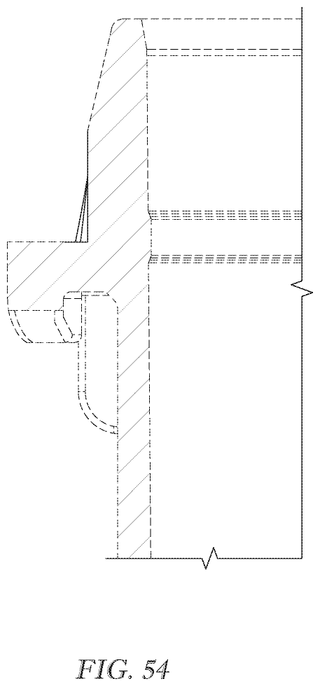

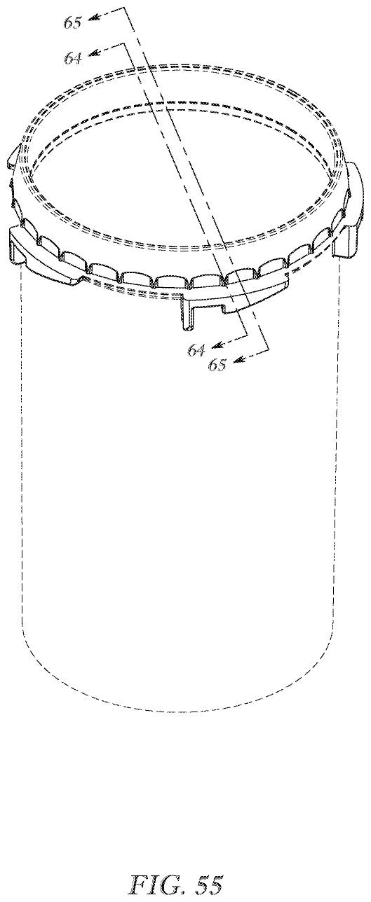

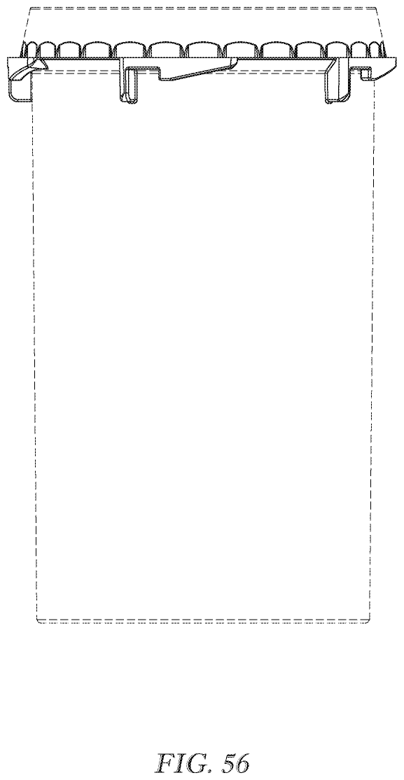

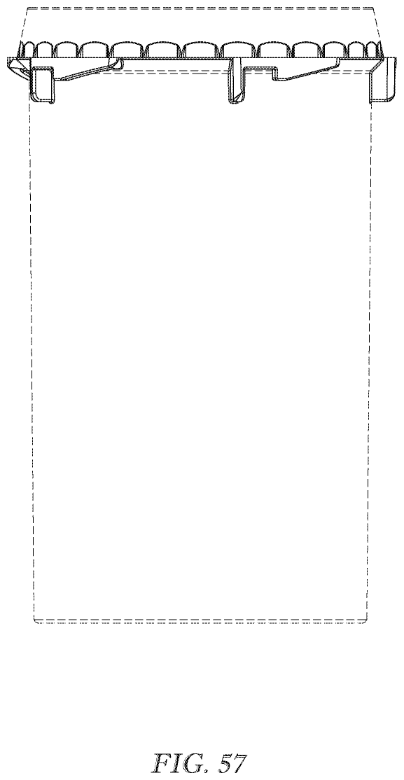

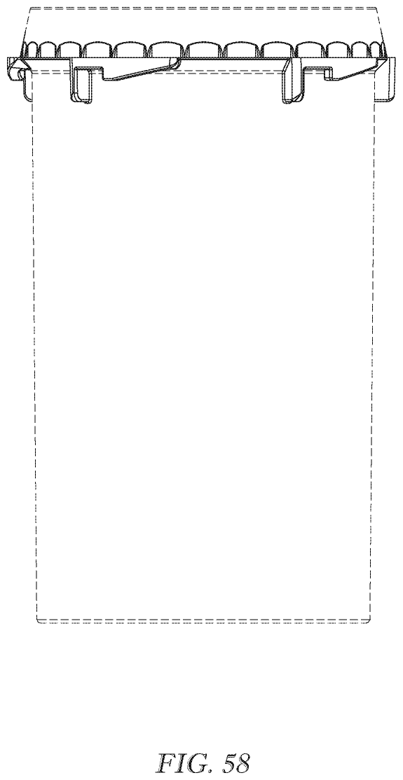

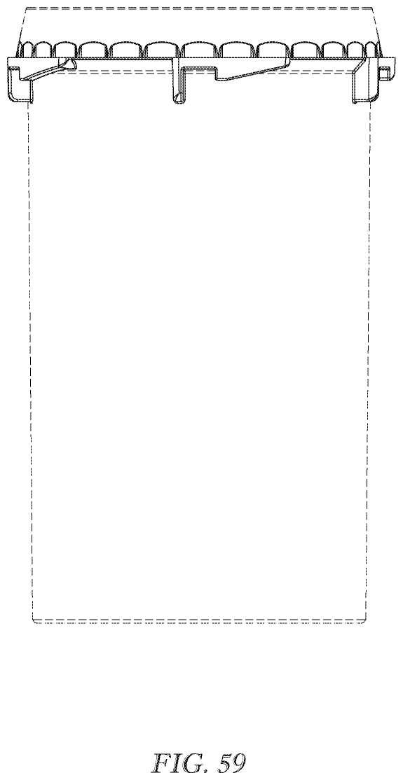

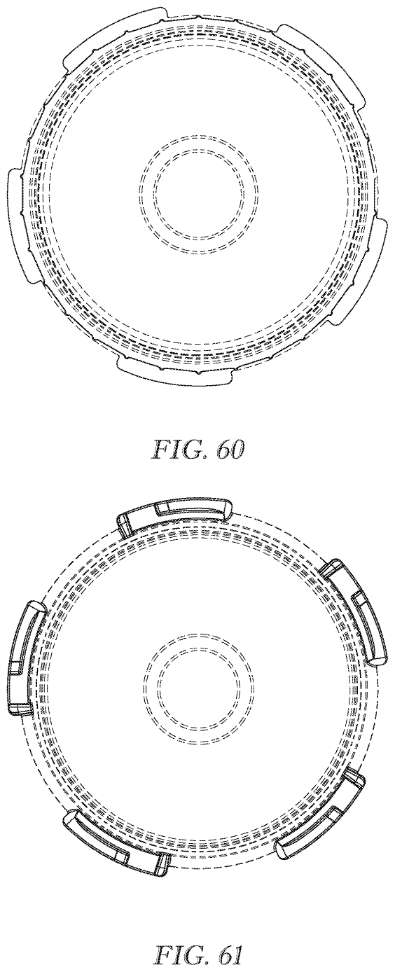

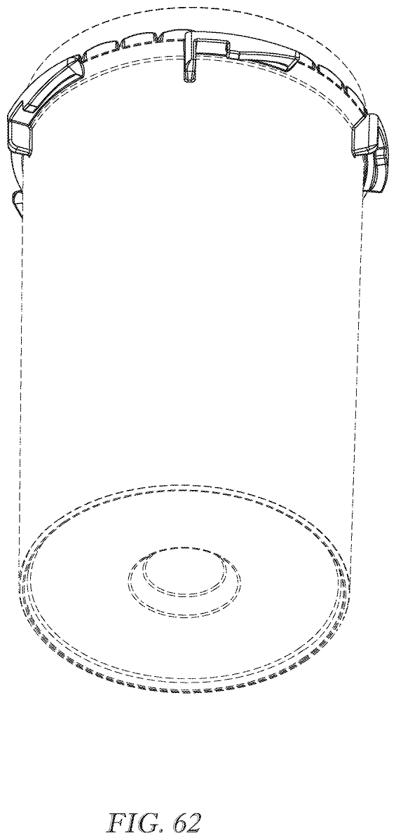

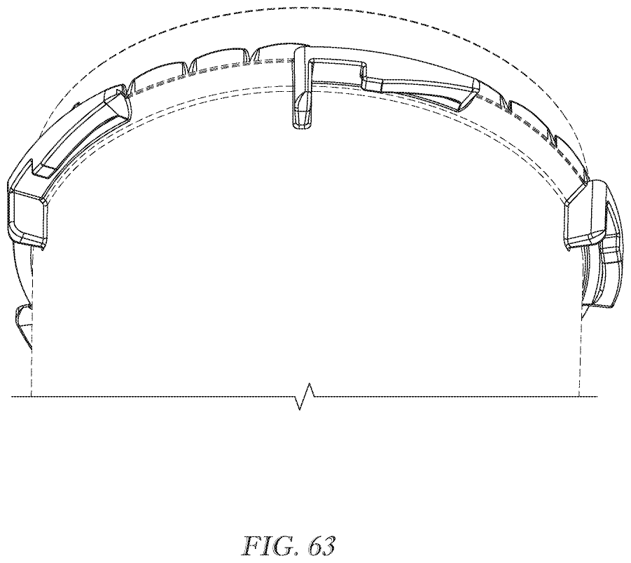

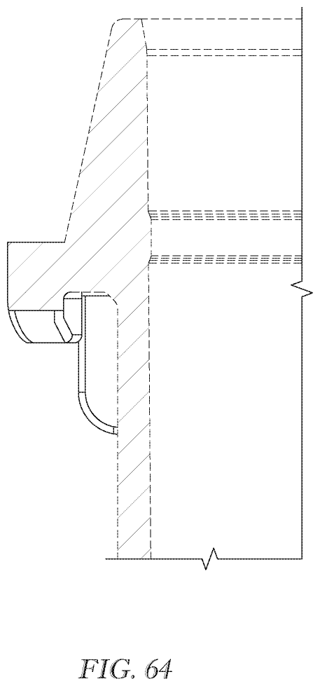

A comparative vial design that lacks a closure retainer defining a space between a side wall and a ramp member of the closure retainer is shown in FIGS. 13A-13B. In contrast to the vial 12 of the present disclosure, shown in FIGS. 14A-14B, the comparative vial design in FIGS. 13A-13B has a thicker lip flange that extends axially along the side wall of the vial, and the closure retainer abuts the flange such that there is no gap between the flange and the closure retainer. The thinner flange 24 and the space 35 result in faster cooling time of the material. As shown in FIG. 13B, after 11.9 seconds, the comparative design has an average temperature of approximately 303° F. in the area of the thick lip flange and closure retainer. As shown in FIG. 14B, after 11.9 seconds, the vial 12 of the present disclosure has an average temperature of approximately 213° F. in the area of the lip flange 25 and space 35, an average temperature reduction of approximately 90° F. compared to the comparative design.

In some embodiments, the reduction in mass of the vial 12 of the present disclosure can reduce manufacturing cycle time by 2 seconds as compared to the comparative design, resulting in a cycle time of 9.9 seconds. In some embodiments, the manufacturing cycle time may be reduced by more or less than 2 seconds. In some examples, manufacturing simulation results predict an even greater potential cycle time reduction of as much as approximately 4.5 seconds due to the features described here, resulting in a cycle time of approximately 7.4 seconds.

Molding experimentation is ongoing to determine precisely how much cycle time may be saved when balancing different factors of the manufacturing process. For example, when the vial 12 is molded at faster cycle times with less cooling time, the vial 12 is warmer coming out of the mold. As the unconstrained vial 12 continues to cool to ambient temperature outside of the mold, the vial 12 shrinks more and its dimensions change. The dimensions of the vial 12 are only slightly different and predominately within specification at a cycle time of approximately 9.9 seconds when the cooling time is reduced by only 2 seconds.

Greater change in dimensions of the vial 12 are observed at a cycle time of approximately 7.4 seconds when the cooling time is reduced by approximately 4.5 seconds. However, the final dimensions of the vial 12 may not be within specification due to the additional post-mold shrinkage as the warmer, unconstrained vial 12 cools to ambient temperature outside of the mold.

Ongoing experimentation will determine which combination of cavity dimension adjustments within the mold will offset the post-mold shrinkage to produce the vial 12 within specification at a reduced cycle time. The end result will likely be achieving a vial 12 within specification at a cycle time reduction of between approximately 2 to 4.5 seconds, at a cycle time of between approximately 7.4 to 9.9 seconds.

The closure 14 includes a round top wall 36 and an annular sidewall 38 that is arranged to extend in a downward direction from the top wall 36. The top wall 36 and side wall 38 form an interior region 40 of closure 14. The closure 14 includes a plurality of closure anchors 22 that are coupled to an inside surface 23 of side wall 38 in the interior region 40. The plurality of closure anchors 22 are configured to engage the plurality of closure retainers 34 so that the closure 14 is retained to the vial 12 after rotation of the closure 14 about the axis of rotation 17.

Each ramp member 60 is configured to engage one of the plurality of closure anchors as the closure 14 is rotated in a closure-installation direction toward the installed position. Each closure-retainer surface 56 is configured to engage one of the plurality of closure anchors 22 in the installed position to block removal of the closure 14 from the vial 12 along the axis of rotation 17. Each of the plurality of closure retainers 34 is configured to pull the closure 14 toward vial 12 as the closure 14 is rotated in the installation direction and at least some of the closure anchors 22 ride along the ramp surface 64 of each closure retainer 34. When installed, the closure retainers 34 of the closure fit within the closer-retainer gap 66, and the stop member 70 is configured to engage the closure anchors 22 in the installed position to block further rotation of closure 14 in the installation direction.

Each closure anchor 22 is formed generally in the shape of a cube as shown in FIGS. 1 and 4, although other suitable shapes or structures may also be used in other embodiments. During installation of the closure 14, the closure 14 is placed on top of the mouth 15 of the vial, with the closure anchors 22 inserted circumferentially between the closure retainers 34. The closure 14 is then rotated in the installation direction such that the closure anchors 22 engage and slide along the ramp surface 64 of a corresponding closure retainer 34. The closure 14 continues to rotate until the closure anchors 22 come to the closer-retainer gap 66, and fit withing the gap 66. The stop member 70 prevents further rotation of the closure 14.

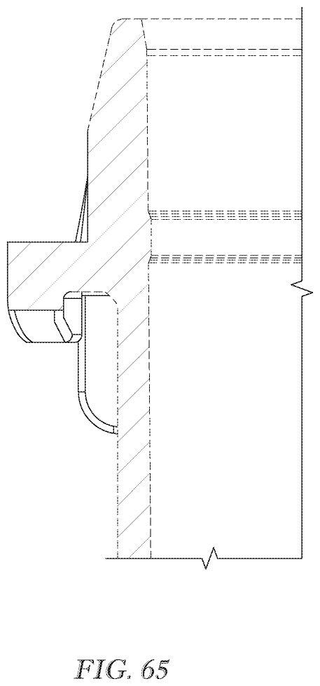

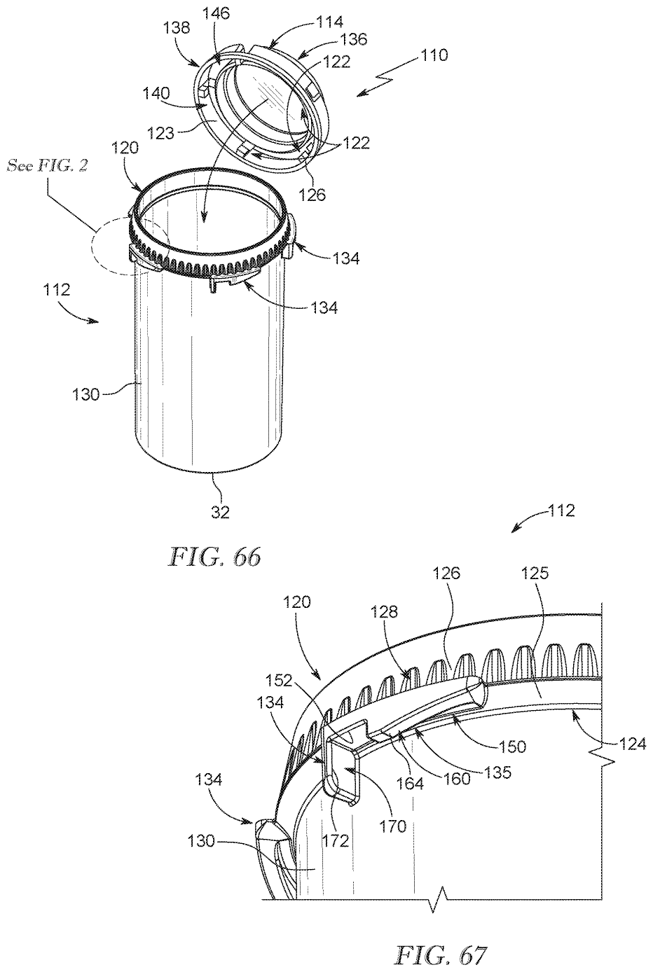

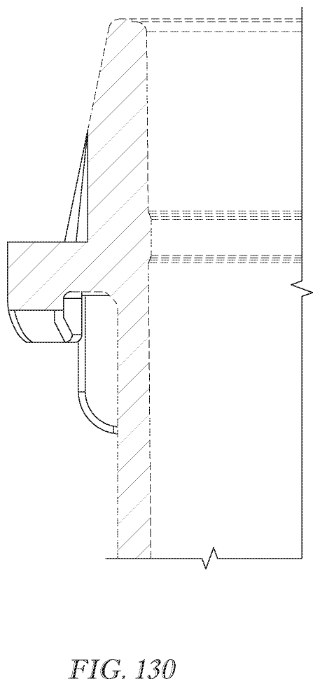

Another embodiment of a vial 112 in accordance with the present disclosure is shown in FIGS. 66-130. The vial 112 is similar to the vial 12 shown FIGS. 1-65 and described herein. Accordingly, similar reference numbers in the 100 series indicate features that are common between the vial 12 and the vial 112. The description of the vial 12 is incorporated by reference to apply to the vial 112, except in instances when it conflicts with the specific description and the drawings of the vial 112. The vial 112 comprises a vial body include a side wall 130 and a floor 132. The upper end of the side wall 132 forms a mouth 115 of the vial 112. The floor 132 is coupled to a lower end of the side wall 130 and cooperates with the side wall 130 to define a product-storage chamber. The vial 112 further includes a lip 120 extending radially out from the side wall 130 relative to an axis of rotation 117. The lip 120 extends axially along the side wall 130 from the mouth 115 towards the lower end of the side wall 30. The lower edge of the lip 120 forms a lip flange 124.

The vial 112 includes at least one closure retainer 134 coupled to the lip flange 124. The closure retainer 134 includes an attachment member 150, a ramp member 160, and a stop member 170. The attachment member 150 is coupled to the lip flange 124, coupling the closure retainer 134 to the lip flange 124. The attachment member 150 extends radially outward from the lip flange 124. The ramp member 160 is coupled to the attachment member 150 and extends out axially from the attachment member 150 towards the floor 132 of the vial 112, parallel to the side wall 130. The stop member 170 is coupled to the attachment member 150 and extends axially from the attachment member 150 towards the floor 132 of the vial 112 and perpendicular to the side wall 130.

The ramp member 160 is offset from the side wall 130 to define a space 135 disposed radially between the side wall 130 and the ramp member 160. A radially outer surface of the side wall 130, a radially inner surface 162 of the ramp member 160, and a bottom, radially extending surface 152 of the attachment member 150 define the space between the ramp member 160 and the side wall 130. The space 135 decreases the cooling time of the vial 112 and causes cycle time of the vial 112 during manufacturing to decrease.

Turning to the figures, a child-resistant package 110 includes a vial 112, or container, and a closure 114 mounted on vial 112 to cover a mouth 115 opening into a product-storage chamber 116 formed in vial 112, as shown in the illustrative embodiment of FIG. 66. The vial 112 is adapted to accept the closure 114 to seal in the contents of vial 112. The product-storage chamber 116 is adapted to contain a product, such as medication, and is sealed when the closure 114 is coupled to the vial 112.

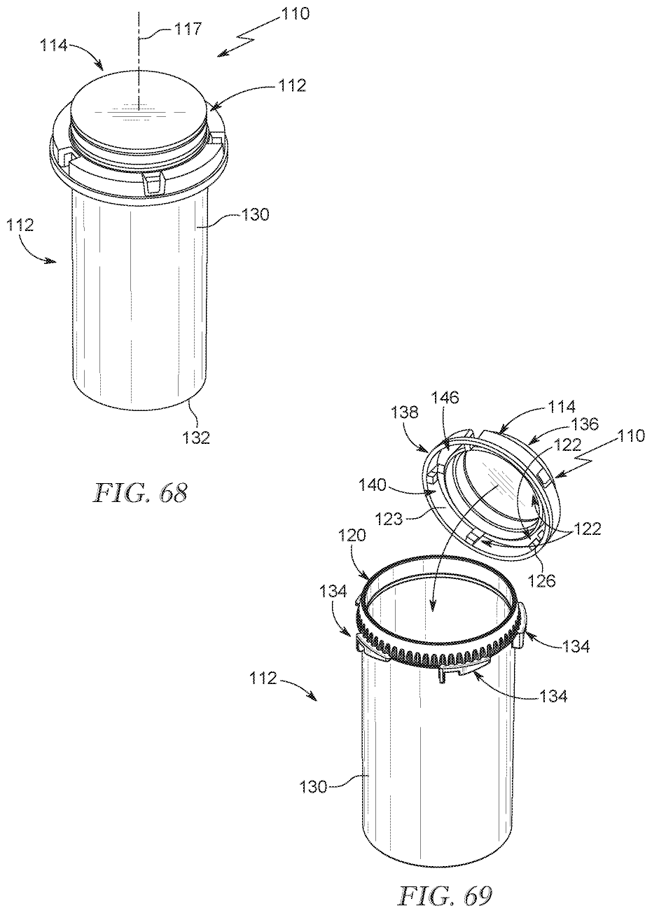

The vial 112 includes an annular sidewall 130 and a floor 132 coupled to a lower end of the side wall 130. The side wall 130 includes a lip 120 and a plurality of closure retainers 134 coupled to an outer surface of the lip 120 as shown in FIG. 67. The side wall 130 extends vertically along an axis 117 of the child-resistant package 110. The side wall 130 and the floor 132 cooperate to define the product-storage chamber 116 of vial 112. The plurality of closure retainers 134 extend outwardly away from the axis 117, or radially out from a radially outer surface of the lip 120 and are configured to cooperate with the closure 114 to retain the closure 114 on vial 112 in a full-installed position as shown in FIG. 68. The closure 114 is arranged to be coupled to the vial 112 after rotation of the closure 114 about the axis of rotation 117.

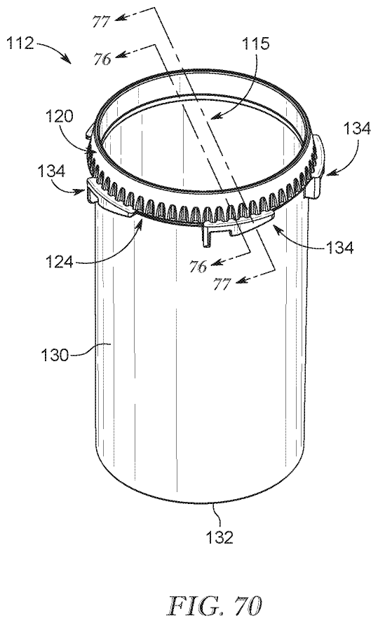

As show in FIG. 70, the lip 120 extends radially outwards from the side wall 130, away from the axis 117. The lip 120 extends axially at least partially along the outer surface of the side wall 130 from the mouth 115 towards the lower end of the side wall 130. In the illustrative embodiment, the lip 120 extends circumferentially around an entire circumference of the mouth 115 of the vial 112. In other embodiments, the lip 120 extends partially around the circumference of the vial 112. In the illustrative embodiments, the lip 120 is tapered, with a radial thickness of the lip 120 increasing in the axial direction as the lip 120 extends along the side wall 130 away from the mouth 115.

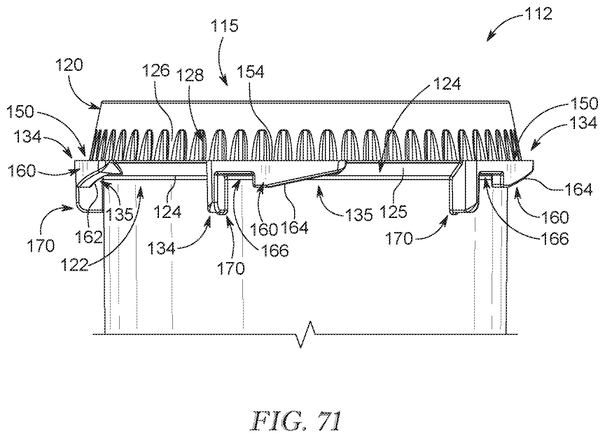

As show in FIGS. 70-71, in the illustrative embodiment, the lip 120 includes a plurality of projections 126 extending radially outward from the lip 120. In some embodiments, the lip 120 may not include projections. The projections 126 are circumferentially spaced apart from around the circumference of the lip 120 to define recesses 128 or spaces between a corresponding pair of projections 126. In the illustrative embodiments, the projections 126 and recesses 128 form a scallop pattern extending around the lip 120, where the recesses 128 each have a curved upper edge disposed opposite the radially extending surface 154 of the lip 120. In the illustrative embodiment, each of the recesses 128 extends a longer axial distance along the axis 117 than a distance the recess 128 extends circumferentially around a circumference of the lip 120, forming relatively narrow recesses 128 and narrow projections in the circumferential direction relative to the axis 117.

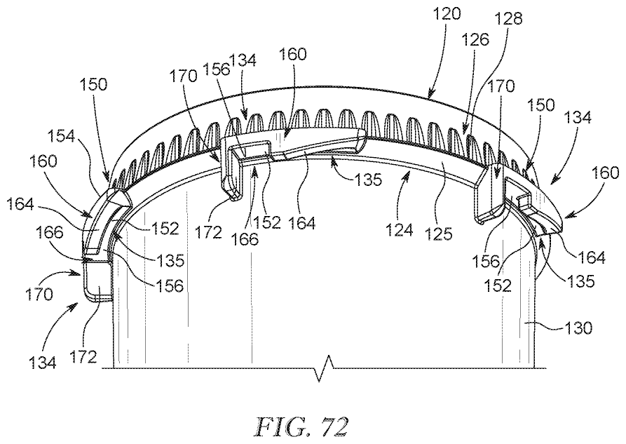

As shown in FIG. 72, a lower edge of the lip 120 forms a lip flange 124. The lip flange 124 may comprise a flange surface 125, extending from a radially-most outer portion of the lip 120 inwards to an outer surface of the sidewall 130. In the illustrative embodiment, the lip flange 124 is tapered such that the flange 125 surface extends both in the radial and axial directions relative to the axis 117. The closure retainers 134 are coupled to the flange surface 125 of the lip flange 124, extending radially outward from the flange surface 125. In the illustrative embodiment, the vial 112 comprises a plurality of closure retainers 134 circumferentially spaced apart from each other around the vial 112.

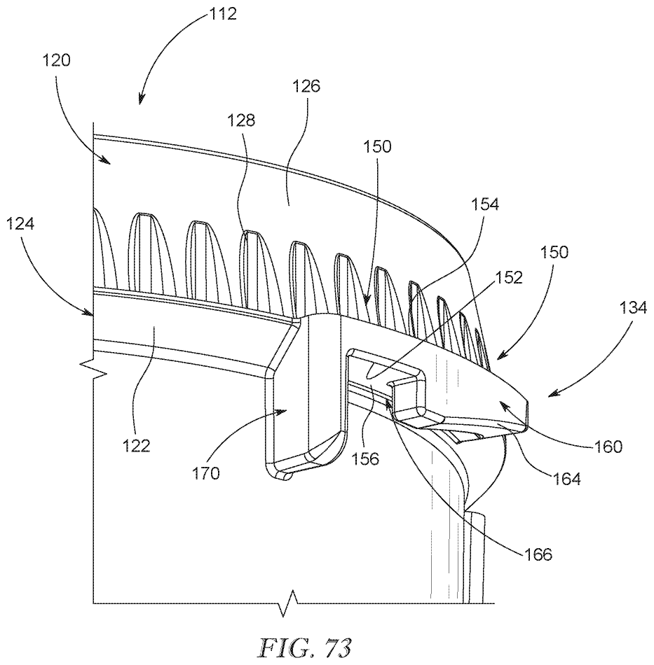

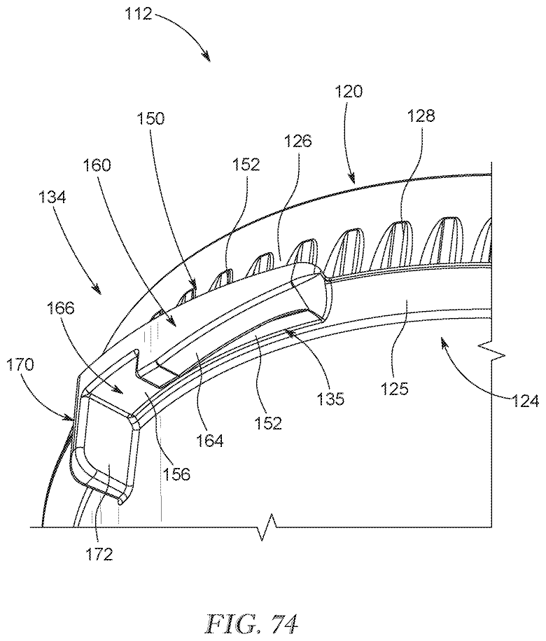

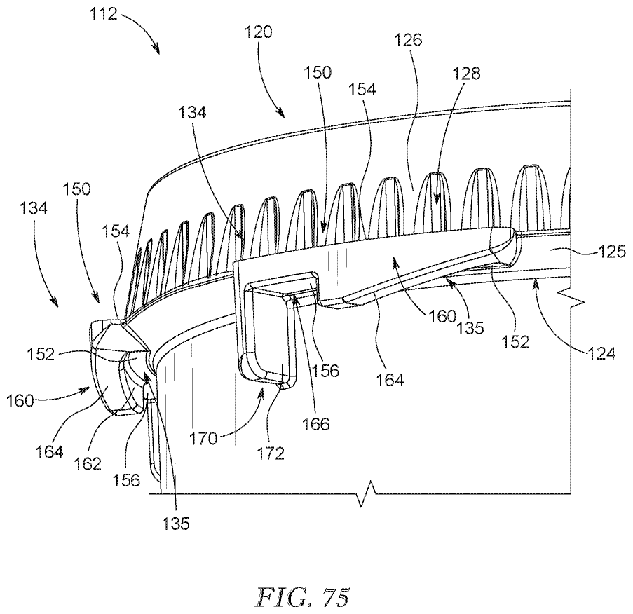

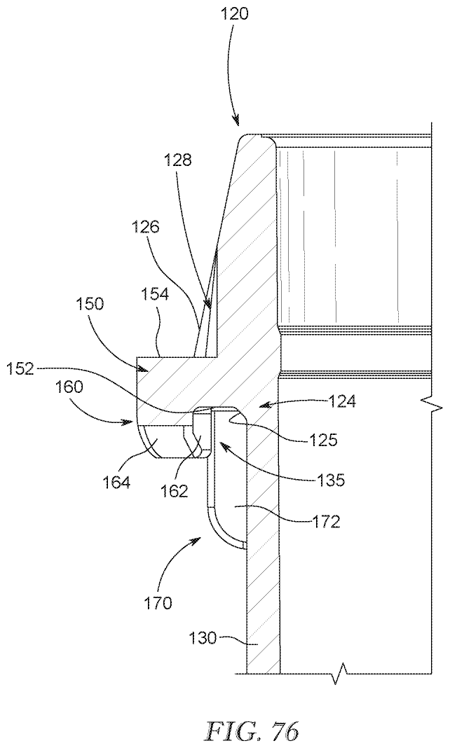

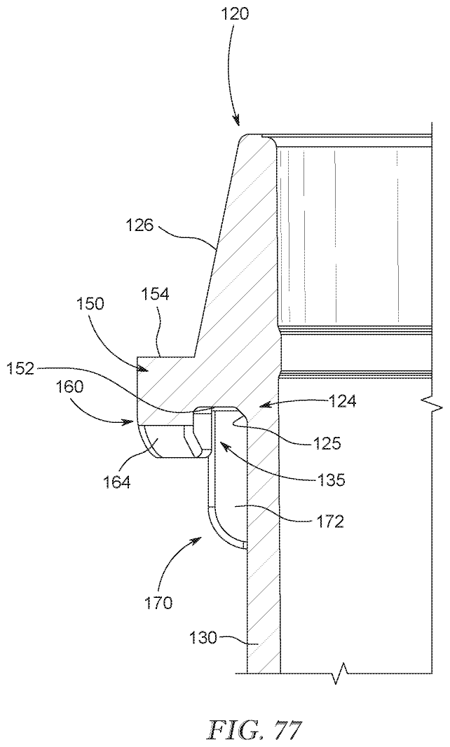

As shown in FIGS. 73-75, in the illustrative embodiment, each of the closure retainers 134 includes an attachment member 150, a ramp member 160, and a stop member 170. The attachment member 150 extends radially outward from the flange surface 125 and couples the closure retainer 134 to flange surface 125 of the lip flange 124. In the illustrative embodiment, the attachment member 150 extends circumferentially along the outer surface of the side wall 130 and extends outwards perpendicular to the side wall 130. A bottom, radially extending surface 152 of the attachment member 150 at least partially defines the space 135 between the ramp member 160 and the side wall 130. An upper, radially extending surface 154 of the attachment member 150 extends outward from the lower edge of the lip 120 at an upper end of the lip flange 124.

The ramp member 160 is coupled to a radially outer portion of the attachment member 150 and extends away from the attachment member 150 in the axial direction. The ramp member 160 extends axially away from the mouth 115 of the vial 112 and towards the floor 132. In the illustrative embodiment, the ramp member 160 extends parallel to the side wall 130, off set from the side wall 130. An inner, radially extending surface 162 of the ramp member 160 is disposed opposite from and faces the outer surface of the side wall 130. The inner surface 162 at least partially defines the space 135 between the ramp member 160 and the side wall 130, the space 135 disposed radially between the outer surface of the side wall 130 and the inner surface 162 of the ramp member 160.

The ramp member 160 includes a radially extending ramp surface 164 that forms a bottom edge of the ramp member 160, the edge of the ramp member 160 is disposed closest to the floor 132 of the vial 112 in the axial direction. The ramp surface 164 engages the closure 114 as the closure 114 is rotated in a closure-installation direction towards the installed position, shown in FIG. 68.

The stop member 170 is coupled to the attachment member 150. In the illustrative embodiment, the stop member 170 is coupled to a circumferential end portion of the attachment member 150. The stop member 170 extends axially away from the attachment member 150 towards the floor 132 of the vial 112. In the illustrative embodiment, the stop member 170 is coupled to the side wall 130 and extends perpendicular to the side wall 130. The stop member is configured to engage the closure 114 in an installed position to block rotation of the closure 114 in a closure-installation direction. An axially extending inner surface 172 of the stop member partially defines the space 135 disposed between the side wall 135 and the ramp member 160.

In the illustrative embodiment, the ramp member 160 and the stop member 170 are circumferentially spaced apart by a portion of the attachment member 150 to define a closure-retainer gap 166 disposed circumferentially between the ramp member 160 and the stop member 170. The bottom surface 152 of the stop member 170 includes a closure-retainer surface 156 that extends between the ramp member 160 and the stop member 170 in the closure-retainer gap 166. The closure-retainer surface 156 engages a corresponding closure anchor 122 in an installed position. The closure-retainer surface 156 is offset from the ramp surface 164 of the ramp member 160 such that an axially lower end of the ramp surface 164 is located further away from the mouth 115 of the vial 112 than the closure-retainer surface 156.

In some embodiments, the vial 12 is formed through molding, for example, injection molding. The space 135 defined between the surfaces of the side wall 130 and the ramp member 160 and/or the recesses 128 formed in the lip 120 of the vial 112 advantageously work to remove weight and mass from the vial 112. In some embodiments, the space 135 and/or recesses 128 reduce the weight of the vial 112 by 0.65 g. In some embodiments, the weight may be reduced by more or less than 0.65 g. This helps use less material during manufacturing of the vial 112 and allows for faster cooling of the vial 112 during molding.

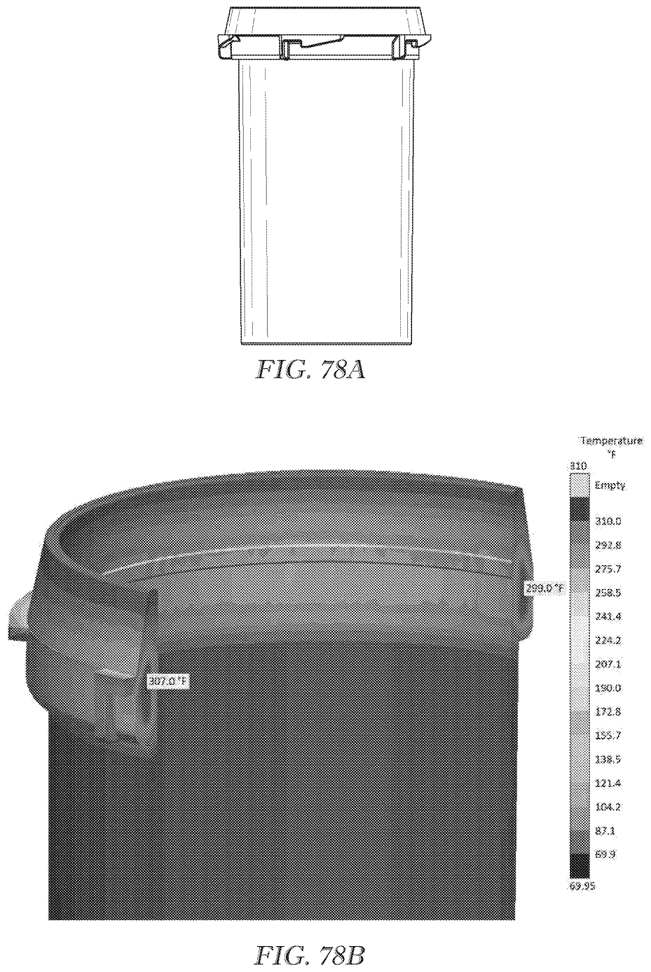

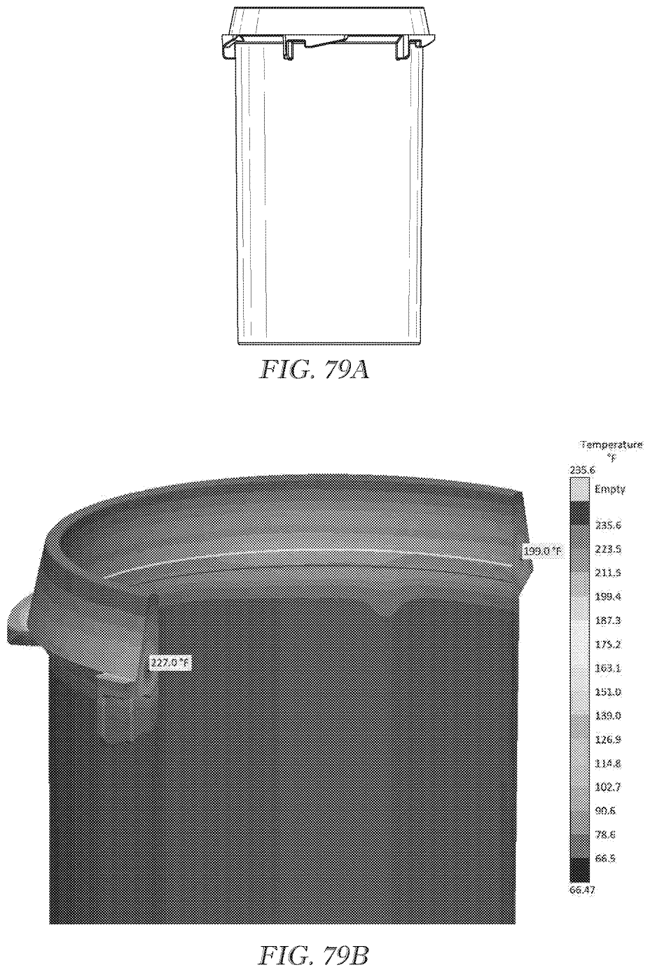

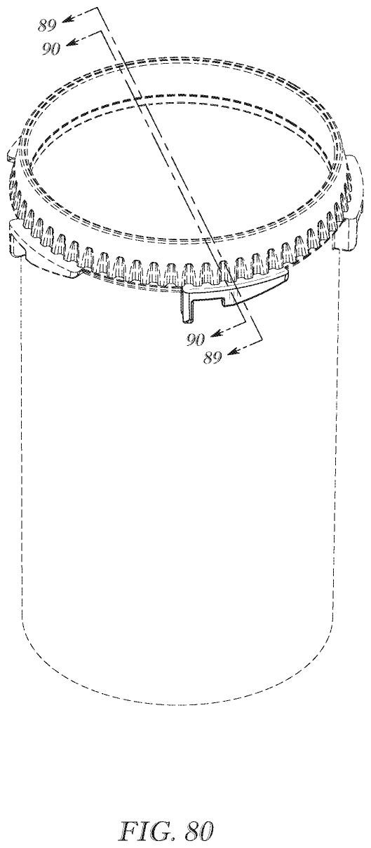

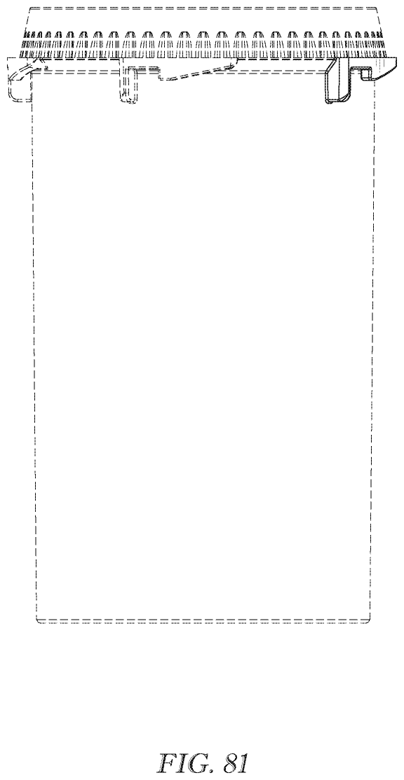

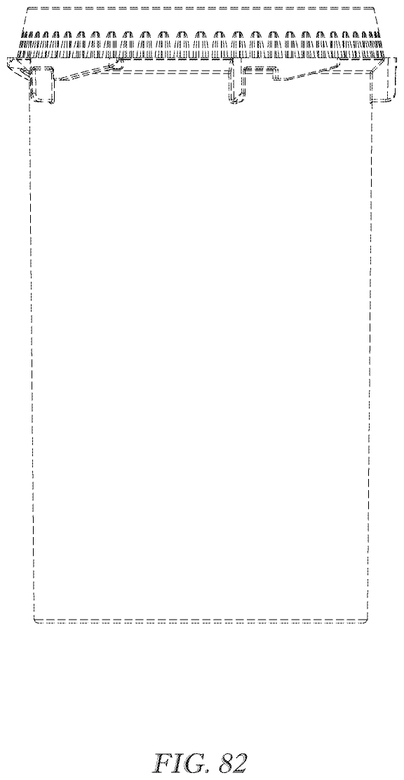

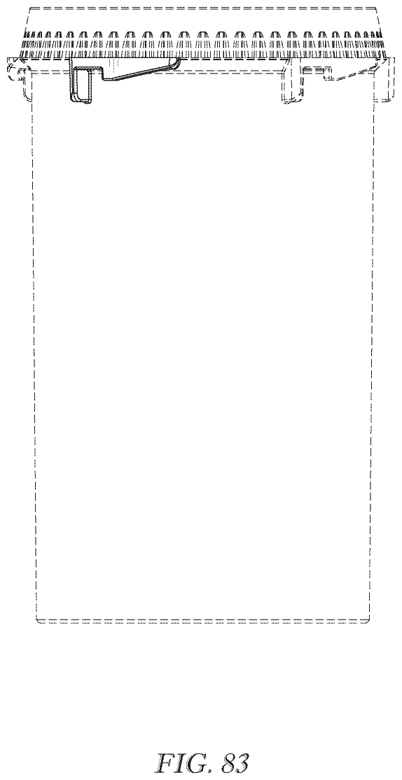

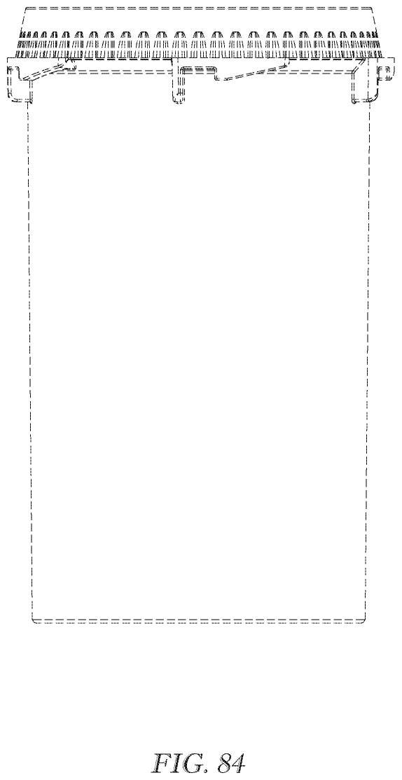

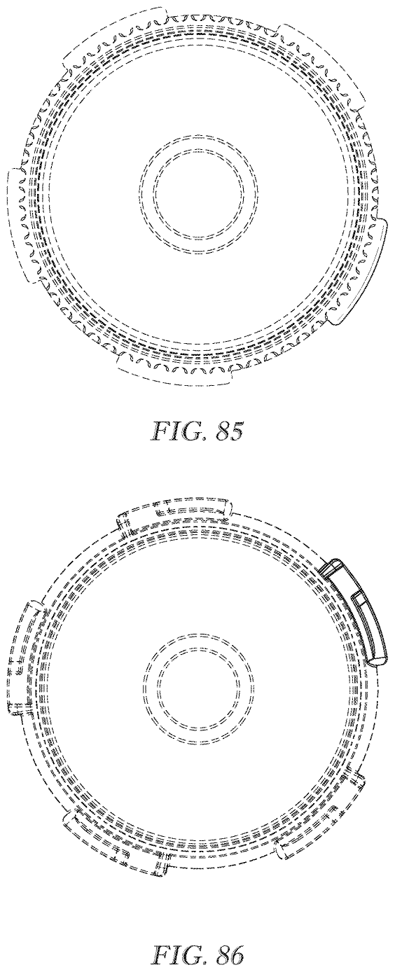

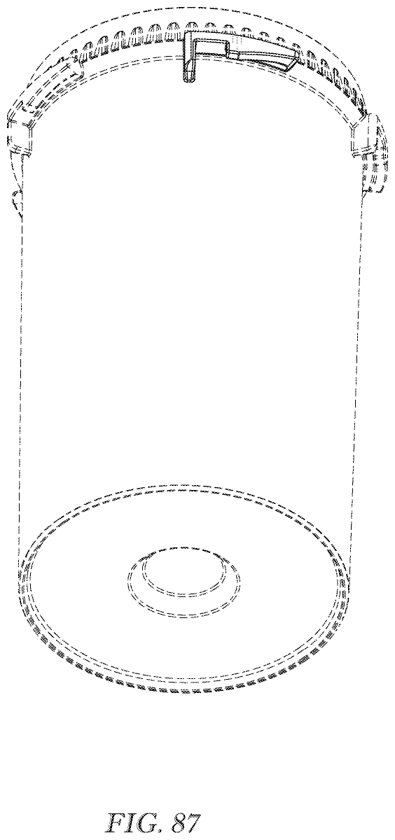

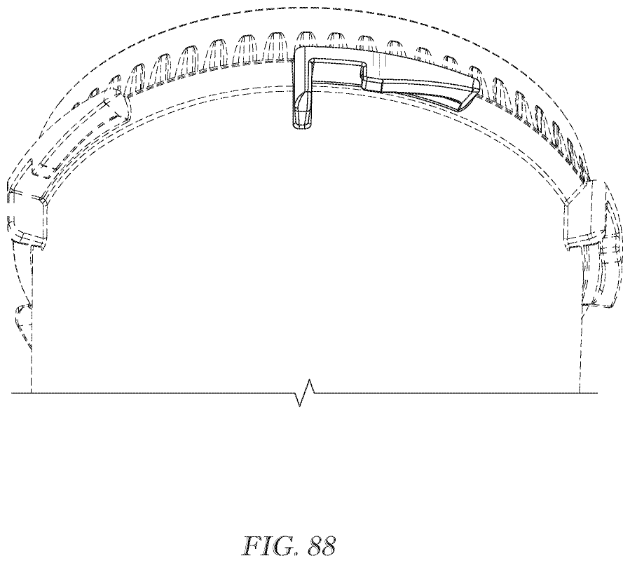

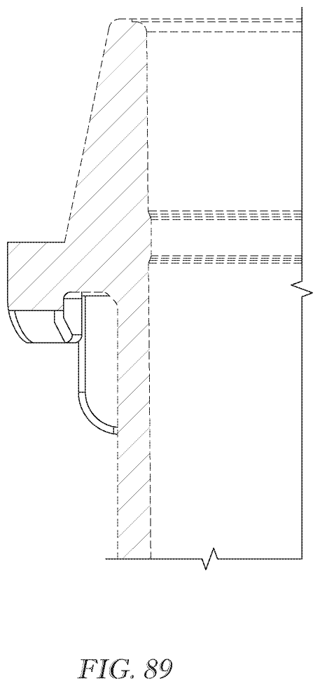

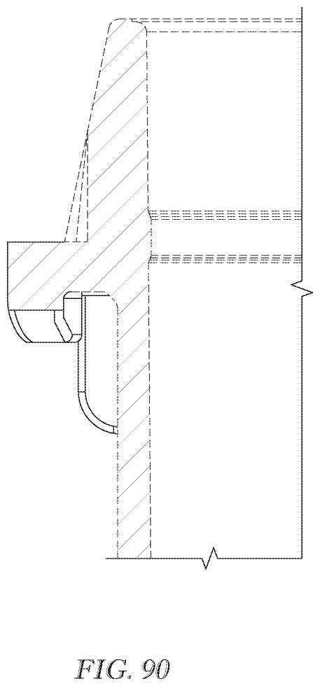

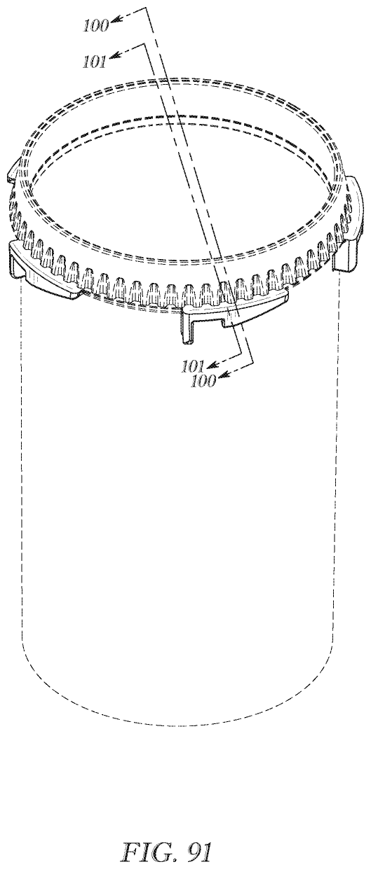

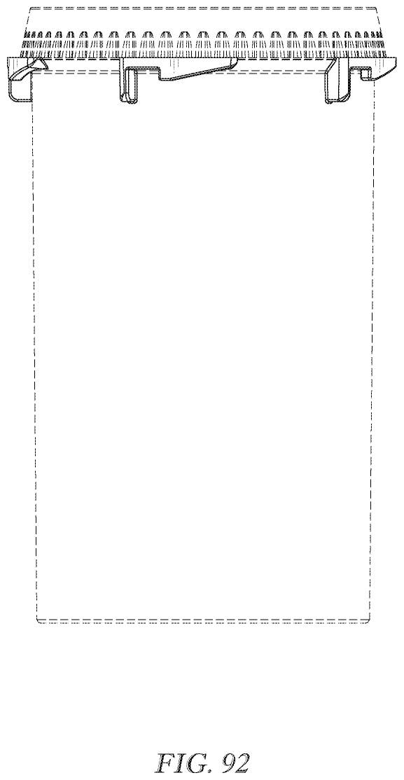

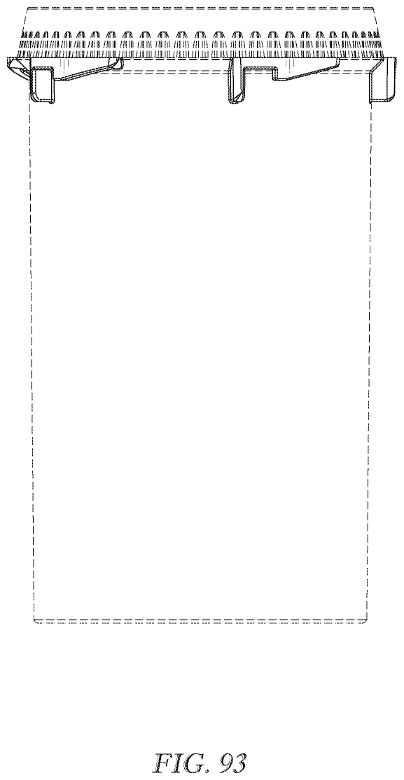

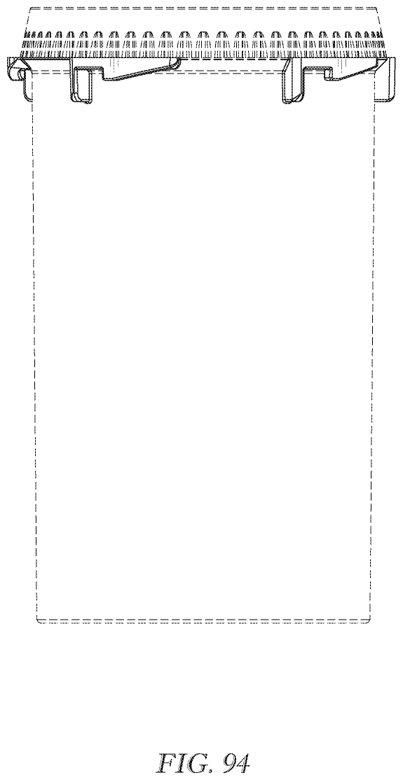

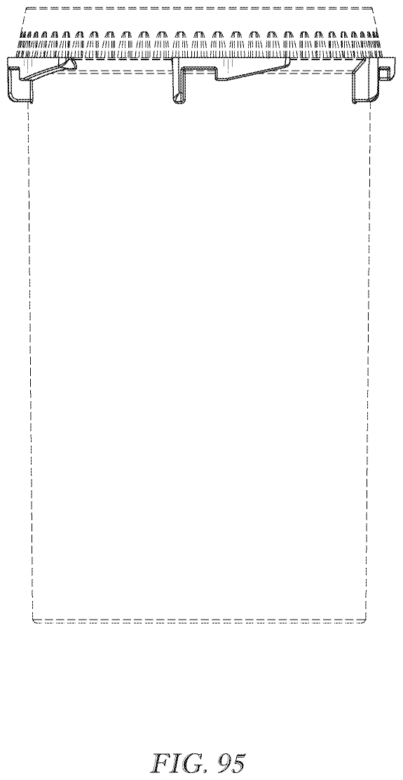

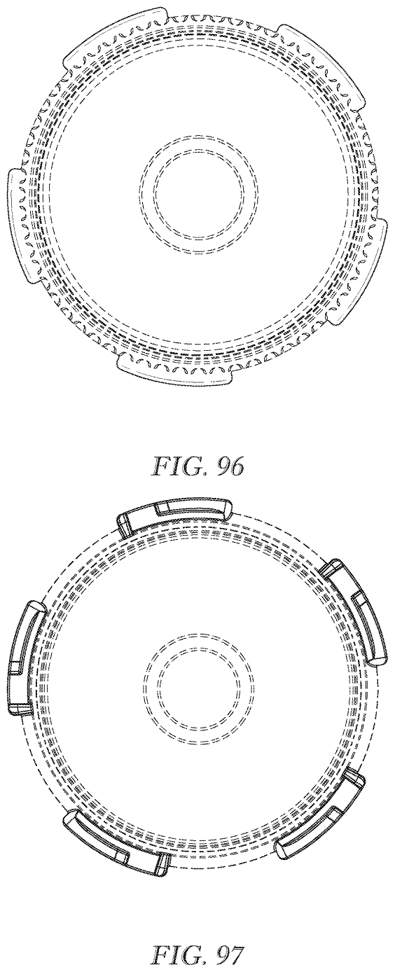

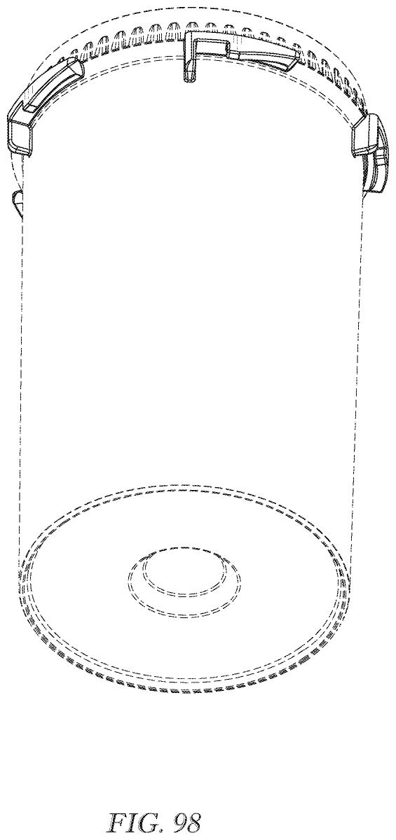

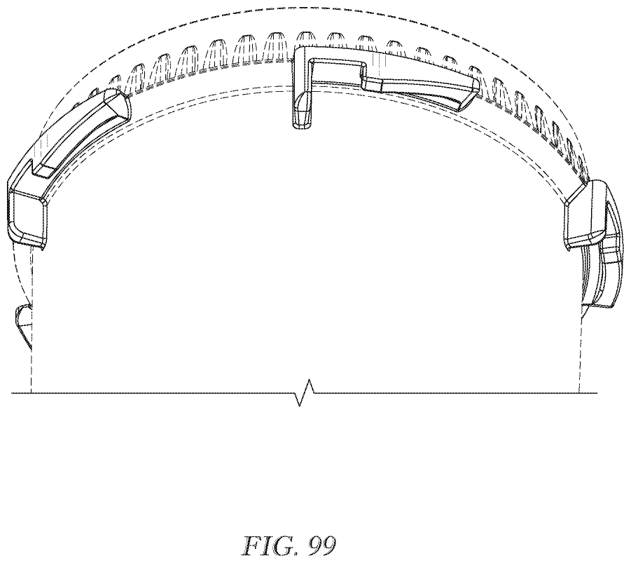

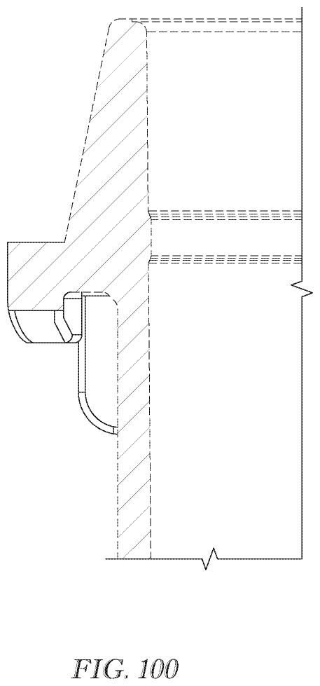

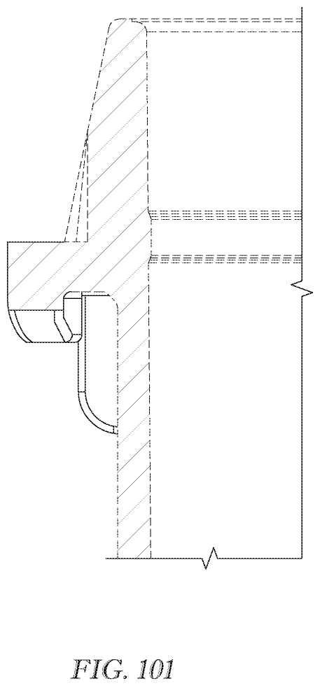

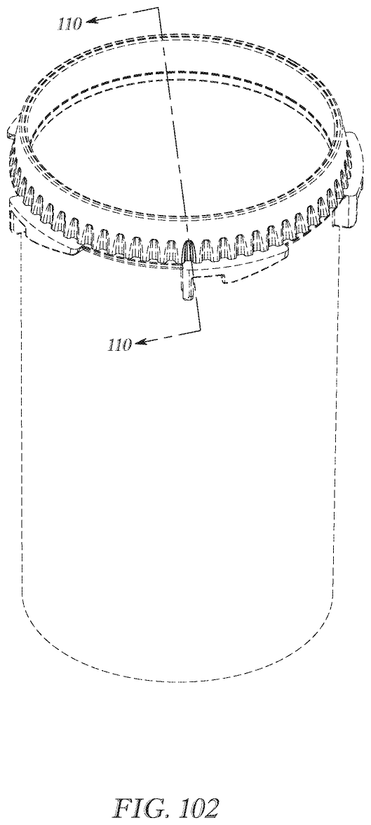

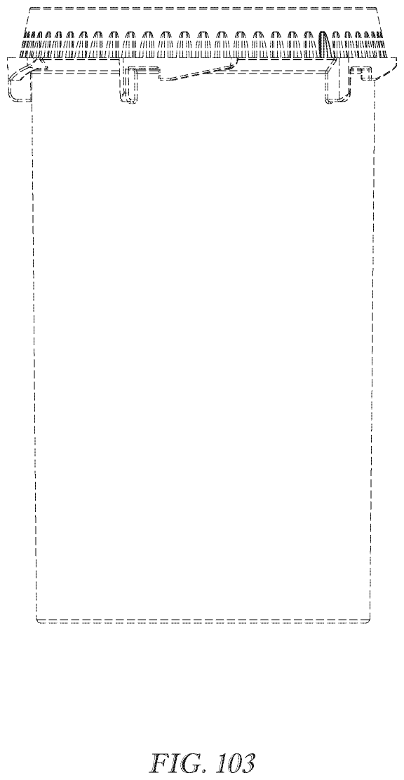

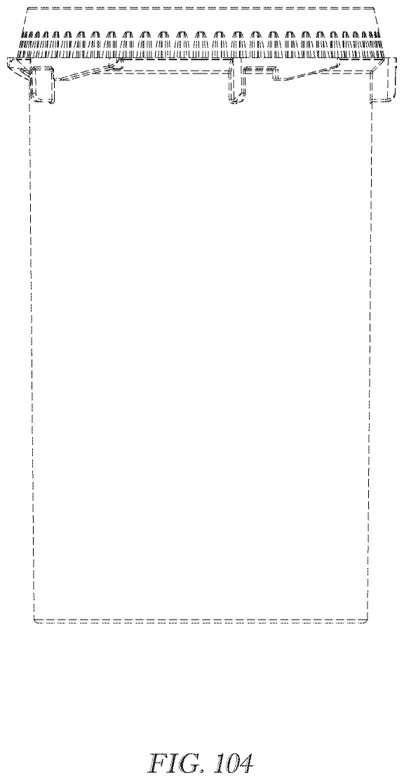

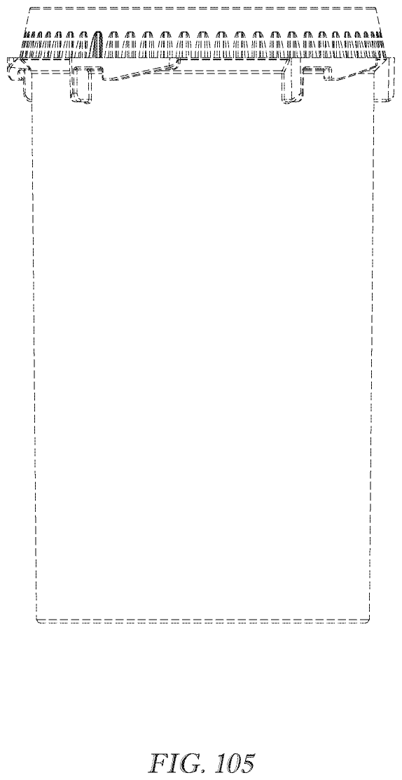

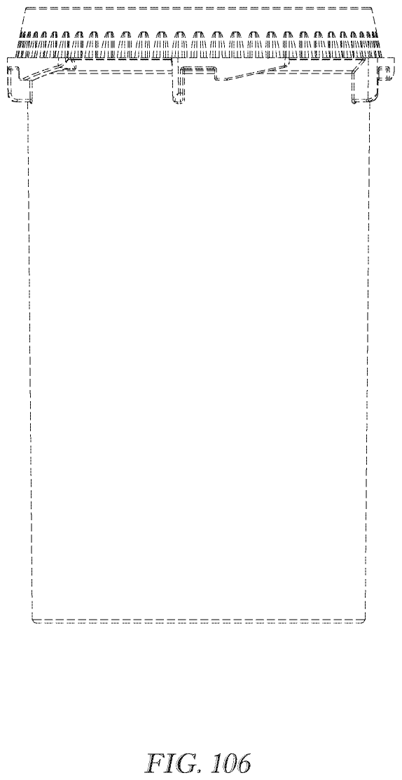

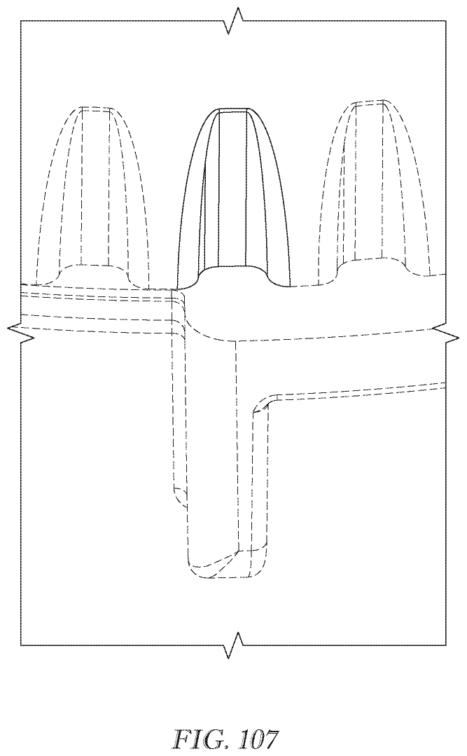

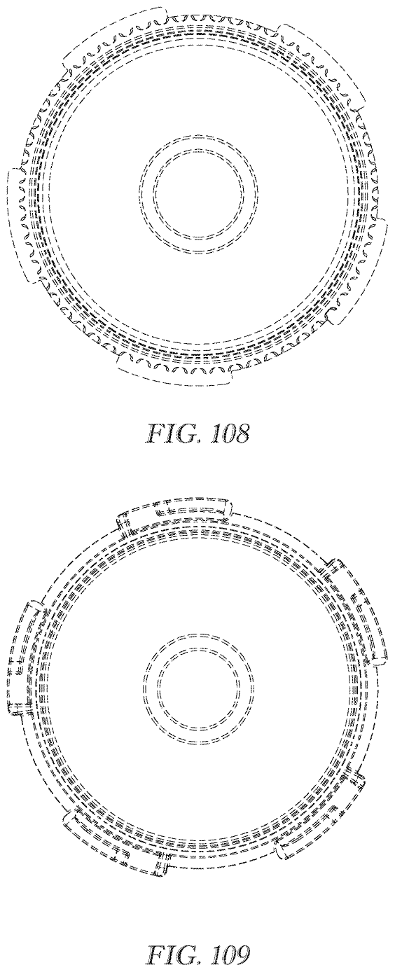

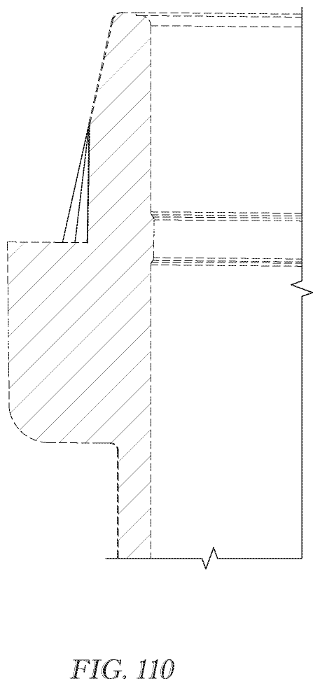

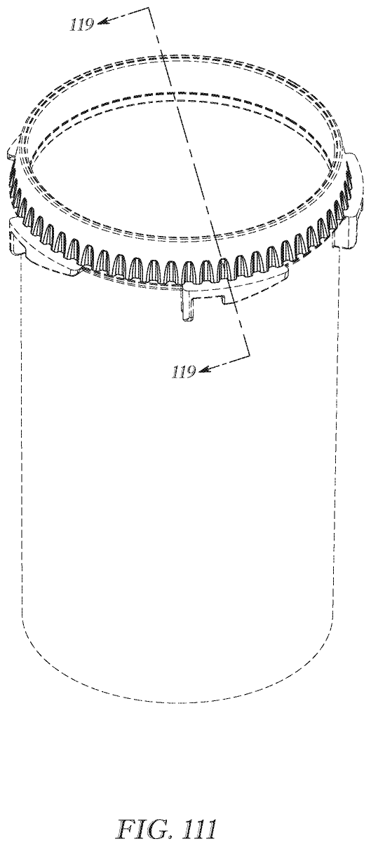

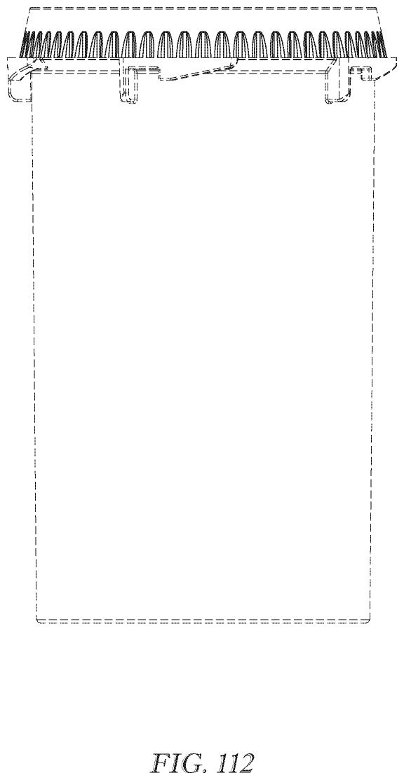

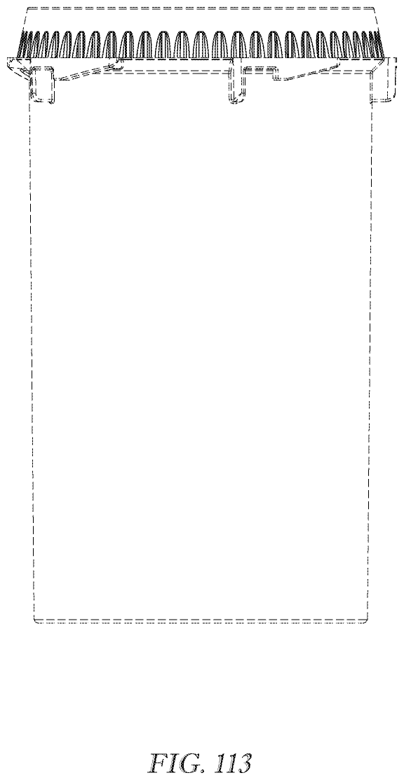

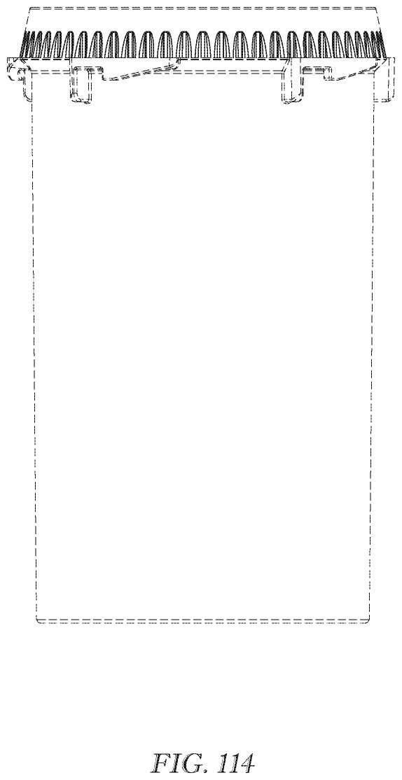

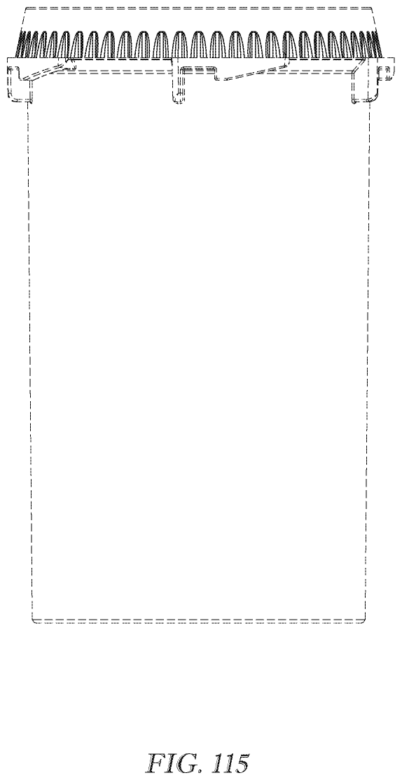

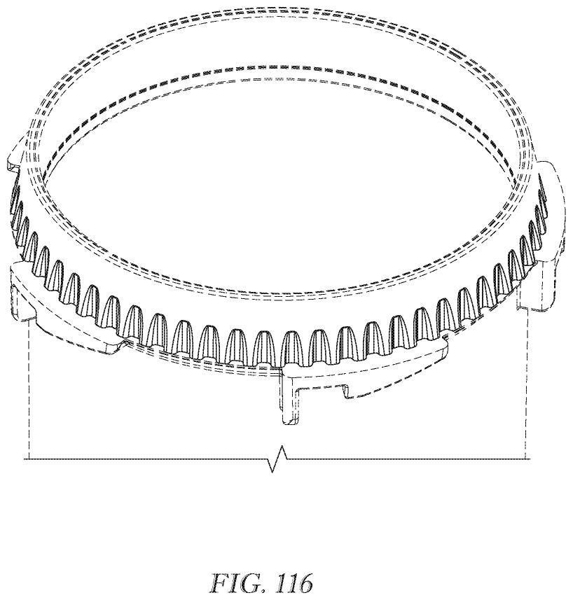

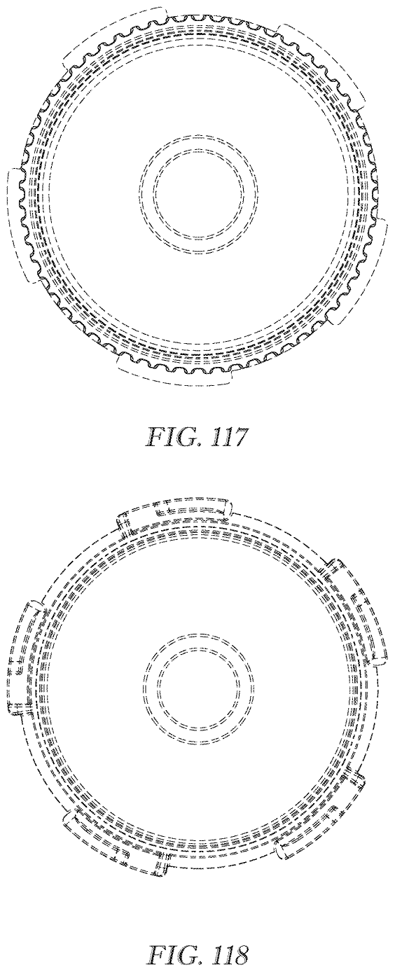

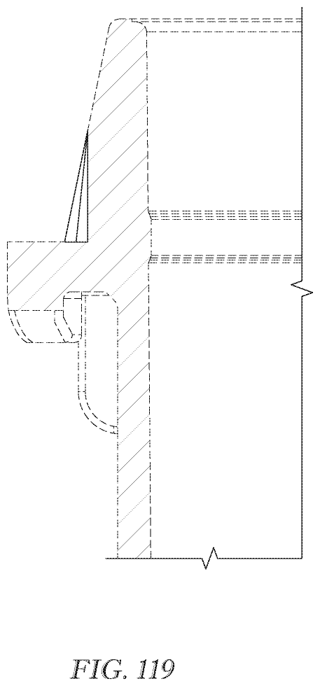

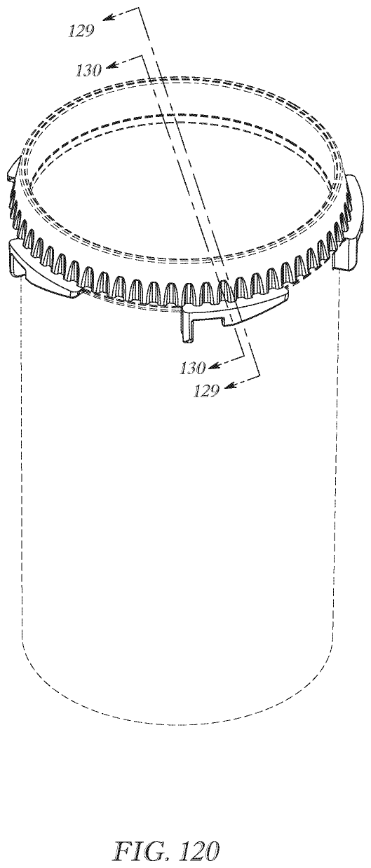

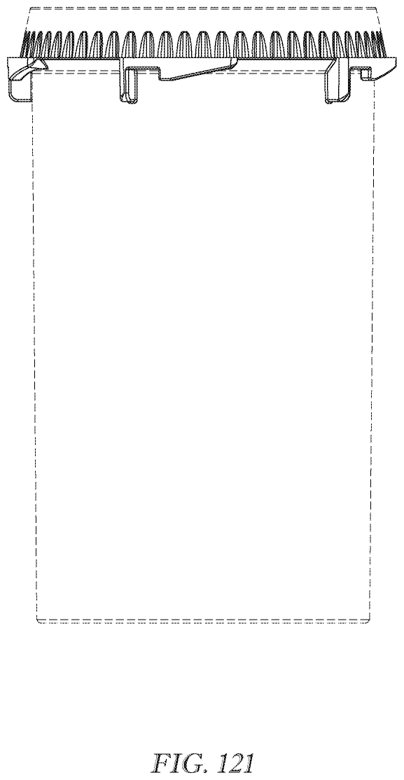

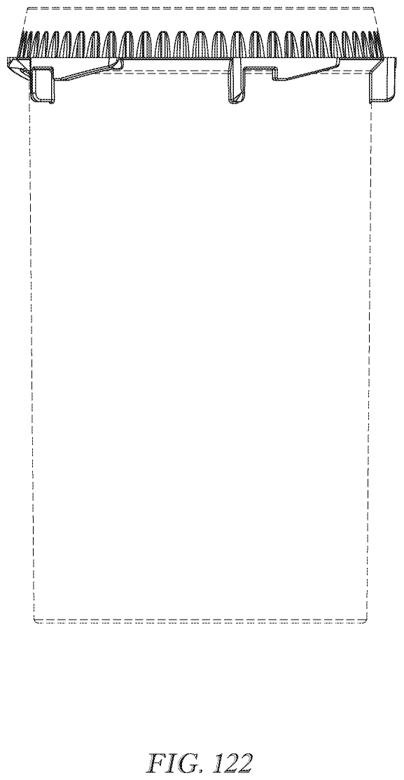

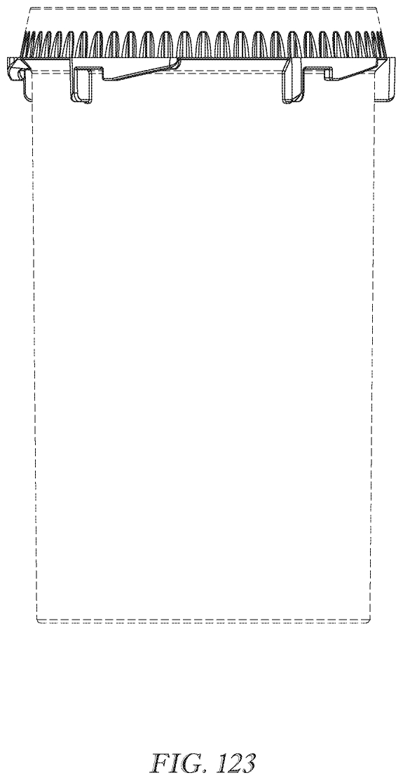

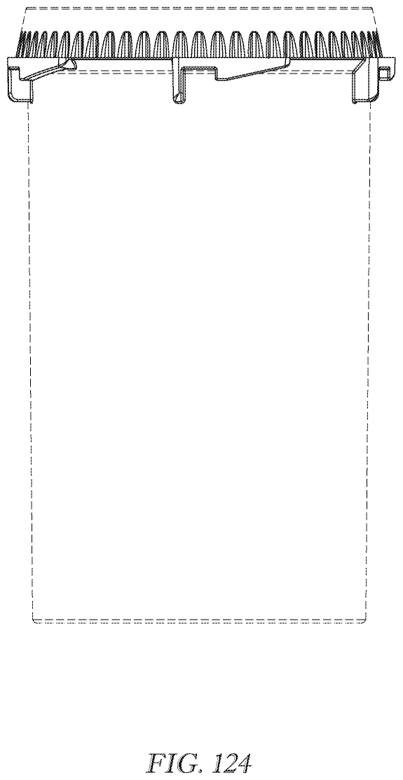

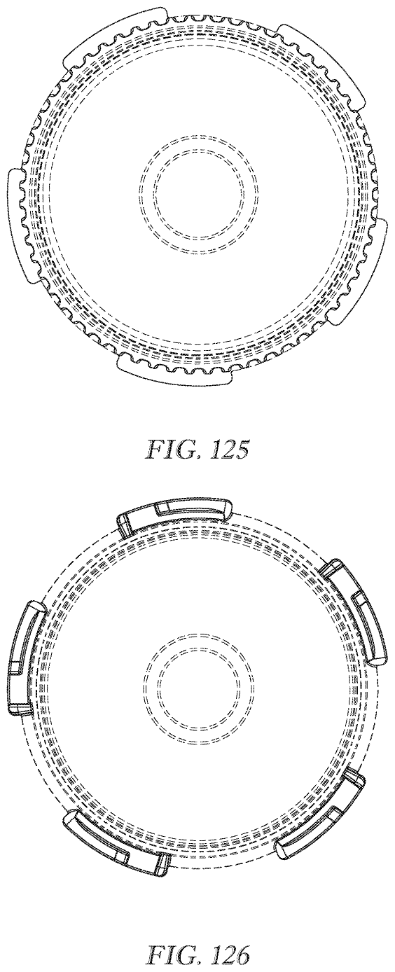

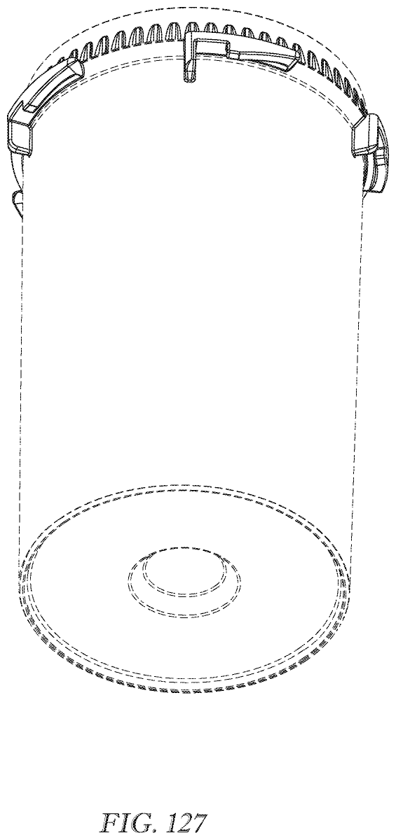

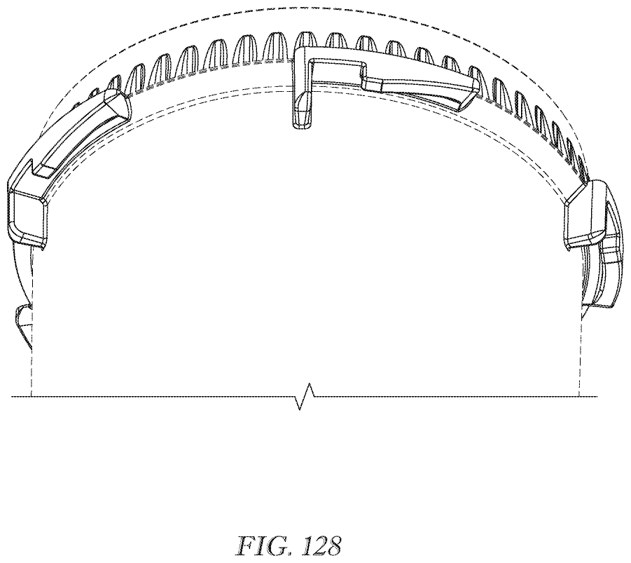

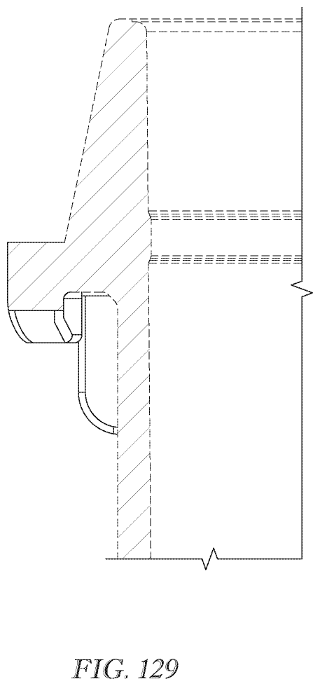

A comparative vial design that lacks a closure retainer defining a space between a side wall and a ramp member of the closure retainer is shown in FIGS. 78A-78B. In contrast to the vial 112 of the present disclosure, shown in FIGS. 79A-79B, the comparative vial design in FIGS. 78A-78B has a thicker lip flange that extends axially along the side wall of the vial, and the closure retainer abuts the flange such that there is no gap between the flange and the closure retainer. The thinner flange 124 and the space 135 result in faster cooling time of the material. As shown in FIG. 78B, after 11.9 seconds, the comparative design has an average temperature of approximately 303° F. in the area of the thick lip flange and closure retainer. As shown in FIG. 79B, after 11.9 seconds, the vial 112 of the present disclosure has an average temperature of approximately 213° F. in the area of the lip flange 125 and space 135, an average temperature reduction of approximately 90° F. compared to the comparative design.

In some embodiments, the reduction in mass of the vial 112 of the present disclosure as compared to the comparative design shown in FIGS. 78A-78B can reduce manufacturing cycle time by 2 seconds, resulting in a cycle time of 9.9 seconds. In some embodiments, the manufacturing cycle time may be reduced by more or less than 2 seconds. In some examples, manufacturing simulation results predict an even greater potential cycle time reduction of as much as approximately 4.5 seconds due to the features described here, resulting in a cycle time of approximately 7.4 seconds.

Different competing factors in the manufacturing process may be taken into account when determining how much cycle time may be reduced. These competing factors include container weight, cycle time, cooling rate of the container, dimensional stability, and other relevant factors. For example, when the vial 112 is molded at faster cycle times with less cooling time, the vial 112 is warmer coming out of the mold. As the unconstrained vial 112 continues to cool to ambient temperature outside of the mold, the vial 112 shrinks more and its dimensions change. The dimensions of the vial 112 are only slightly different and predominately within specification at a cycle time of approximately 9.9 seconds when the cooling time is reduced by only 2 seconds.

Greater change in dimensions of the vial 112 are observed at a cycle time of approximately 7.4 seconds when the cooling time is reduced by approximately 4.5 seconds. However, the final dimensions of the vial 112 may not be within specification due to the additional post-mold shrinkage as the warmer, unconstrained vial 112 cools to ambient temperature outside of the mold.

These competing factors may be balanced according to the present disclosure to determine which combination of cavity dimension adjustments within the mold will offset the post-mold shrinkage to produce the vial 112 within specification at a reduced cycle time. The end result will likely be achieving a vial 112 within specification at a cycle time reduction of between approximately 2 to 4.5 seconds, at a cycle time of between approximately 7.4 to 9.9 seconds.

The closure 114 includes a round top wall 136 and an annular sidewall 138 that is arranged to extend in a downward direction from the top wall 136. The top wall 136 and side wall 138 form an interior region 140 of closure 114. The closure 114 includes a plurality of closure anchors 122 that are coupled to an inside surface 123 of side wall 138 in the interior region 140. The plurality of closure anchors 122 are configured to engage the plurality of closure retainers 134 so that the closure 114 is retained to the vial 112 after rotation of the closure 114 about the axis of rotation 117.

Each ramp member 160 is configured to engage one of the plurality of closure anchors as the closure 114 is rotated in a closure-installation direction toward the installed position. Each closure-retainer surface 156 is configured to engage one of the plurality of closure anchors 122 in the installed position to block removal of the closure 114 from the vial 112 along the axis of rotation 117. Each of the plurality of closure retainers 134 is configured to pull the closure 114 toward vial 112 as the closure 114 is rotated in the installation direction and at least some of the closure anchors 122 ride along the ramp surface 164 of each closure retainer 134. When installed, the closure retainers 134 of the closure fit within the closer-retainer gap 166, and the stop member 170 is configured to engage the closure anchors 122 in the installed position to block further rotation of closure 114 in the installation direction.

Each closure anchor 122 is formed generally in the shape of a cube as shown in FIGS. 66 and 69, although other suitable shapes or structures may also be used in other embodiments. During installation of the closure 114, the closure 114 is placed on top of the mouth 115 of the vial, with the closure anchors 122 inserted circumferentially between the closure retainers 134. The closure 114 is then rotated in the installation direction such that the closure anchors 122 engage and slide along the ramp surface 164 of a corresponding closure retainer 134. The closure 114 continues to rotate until the closure anchors 122 come to the closer-retainer gap 166, and fit withing the gap 166. The stop member 170 prevents further rotation of the closure 114.

The following numbered clauses include embodiments that are contemplated and non-limiting:

Clause 1. A vial comprising a vial body, a lip, and at least one closure retainer.

Clause 2. The vial of clause 1, any other suitable clause, or any suitable combination of clauses, wherein the vial body includes a side wall and a floor, an upper end of the side wall forming a mouth of the vial, the floor coupled to a lower end of the side wall and cooperating with the side wall to define a product-storage chamber.

Clause 3. The vial of clause 2, any other suitable clause, or any suitable combination of clauses, wherein the lip extends radially out from the side wall relative to an axis of rotation and extends axially along the side wall from the mouth towards the lower end of the side wall, a lower edge of the lip forming a lip flange.

Clause 4. The vial of clause 3, any other suitable clause, or any suitable combination of clauses, wherein the at least one closure retainer is coupled to the lip flange, the at least one closure retainer including an attachment member coupled and extending radially away from the lip flange, a ramp member coupled to and extending axially away from the attachment member towards the floor of the vial, parallel to the side wall, and a stop member coupled to and extending axially away from the attachment member towards the floor of the vial, perpendicular to the side wall.

Clause 5. The vial of clause 4, any other suitable clause, or any suitable combination of clauses, wherein the ramp member is offset from the side wall, a radially outer surface of the side wall, a radially inner surface of the ramp member, and a radially extending surface of the attachment member defining a space between the ramp member and the side wall to decrease cooling time of the vial, causing cycle time of the vial during manufacturing to decrease.

Clause 6. The vial of clause 5, any other suitable clause, or any suitable combination of clauses, wherein the vial comprises a plurality of closure retainers coupled to the lip flange, the plurality of closure retainers circumferentially spaced apart from one another around the vial.

Clause 7. The vial of clause 5, any other suitable clause, or any suitable combination of clauses, wherein the ramp member extends axially along the side wall closer towards the lower edge of the side wall than the lip flange.

Clause 8. The vial of clause 5, any other suitable clause, or any suitable combination of clauses, wherein the ramp member includes a radially extending ramp surface that engages a closure as the closure is rotated in an installation direction towards an installed position.

Clause 9. The vial of clause 5, any other suitable clause, or any suitable combination of clauses, wherein the ramp member is coupled to the attachment member at a radially outer portion of the attachment member.

Clause 10. The vial of clause 5, any other suitable clause, or any suitable combination of clauses, wherein the stop member is coupled to the attachment member at a circumferential end of the attachment member.

Clause 11. The vial of clause 10, any other suitable clause, or any suitable combination of clauses, wherein the stop member is coupled to the side wall.

Clause 12. The vial of clause 5, any other suitable clause, or any suitable combination of clauses, wherein the ramp member and the stop member are circumferentially spaced apart to define a closer-retainer gap.

Clause 13. The vial of clause 12, any other suitable clause, or any suitable combination of clauses, wherein the attachment member includes a closure-retainer surface on a radially extending surface of the attachment member, the closure-retaining surface extending between the ramp member and the stop member to engage a closure in an installed position.

Clause 14. The vial of clause 13, any other suitable clause, or any suitable combination of clauses, wherein the closure-retainer surface is offset from a radially extending ramp surface of the ramp member such that a lower end of the ramp surface is located further away from the mouth of the vial than the closure-retainer surface.

Clause 15. The vial of clause 5, any other suitable clause, or any suitable combination of clauses, wherein the stop member is configured to engage a closure in an installed position to block rotation of the closure in an installation direction.

Clause 16. The vial of clause 5, any other suitable clause, or any suitable combination of clauses, wherein the lip includes a plurality of projections extending radially outward from the lip.

Clause 17. The vial of clause 16, any other suitable clause, or any suitable combination of clauses, wherein the plurality of projections are circumferentially spaced apart from each other around the lip.

Clause 18. The vial of clause 16, any other suitable clause, or any suitable combination of clauses, wherein the plurality of projections are shaped to define recesses between each of the plurality of projections to decrease cooling time of the vial.

Clause 19. A child-resistant package comprises a vial and a closure.

Clause 20. The vial of clause 19, any other suitable clause, or any suitable combination of clauses, wherein the vial includes a side wall forming a mouth of the vial and a floor coupled to a lower end of the side wall and cooperating with the side wall to define a product-storage chamber.

Clause 21. The vial of clause 20, any other suitable clause, or any suitable combination of clauses, wherein the side wall includes a lip extending radially out from the side wall relative to an axis of rotation and axially along the side wall from the mouth towards the lower end of the side wall and a plurality of closure retainers coupled to a lower edge of the lip.

Clause 22. The vial of clause 21, any other suitable clause, or any suitable combination of clauses, wherein each one of the plurality of closure retainers includes an attachment member coupled to and extending radially away from the lip, a ramp member coupled to and extending axially away from the attachment member towards the floor of the vial, and a stop member coupled to and extending axially away from the attachment member towards the floor of the vial.

Clause 23. The vial of clause 22, any other suitable clause, or any suitable combination of clauses, wherein the closure includes a top wall, a side wall being arranged to extend downwardly away from an outer perimeter of the top wall, and a plurality of closure anchors coupled to an inside surface of the side wall and spaced circumferentially from one another about the axis of rotation, the closure configured to mount on the vial to assume an installed position closing the mouth of the vial when rotated relative to the vial about the axis of rotation in an installation direction until each of the plurality of closure retainers overlies a corresponding closure anchor to block separation of the closure from the vial along the axis of rotation.

Clause 24. The vial of clause 23, any other suitable clause, or any suitable combination of clauses, wherein the ramp member of a corresponding one of the plurality of closure retainers is offset from the side wall of the vial, a radially outer surface of the side wall, a radially inner surface of the ramp member, and a radially extending surface of the attachment member defining a space between the ramp member and the side wall to decrease cooling time of the vial, causing cycle time of the vial during manufacturing to decrease.

Clause 25. The vial of clause 24, any other suitable clause, or any suitable combination of clauses, wherein the ramp member includes a radially extending ramp surface that engages the corresponding closure anchor as the closure is rotated in the installation direction towards the installed position.

Clause 26. The vial of clause 25, any other suitable clause, or any suitable combination of clauses, wherein the attachment member includes a closure-retainer surface on a radially extending surface of the attachment member extending between the ramp member and the stop member that engages the corresponding closure anchor in the installed position.

Clause 27. The vial of clause 24, any other suitable clause, or any suitable combination of clauses, wherein the lip includes a plurality of projections extending radially outward from the lip.

Clause 28. The vial of clause 27, any other suitable clause, or any suitable combination of clauses, wherein the plurality of projections are shaped to define spaces between each of the plurality of projections to decrease cooling time of the vial.

Clause 29. A vial comprises a vial body, a lip, and at least one closure retainer.

Clause 30. The vial of clause 29, any other suitable clause, or any suitable combination of clauses, wherein the vial body includes a side wall and a floor, an upper end of the side wall forming a mouth of the vial, the floor coupled to a lower end of the side wall and cooperating with the side wall.

Clause 31. The vial of clause 30, any other suitable clause, or any suitable combination of clauses, wherein the lip extends radially out from the side wall relative to an axis of rotation and extends axially along the side wall from the mouth towards the lower end of the side wall, a lower edge of the lip forming a lip flange.

Clause 32. The vial of clause 31, any other suitable clause, or any suitable combination of clauses, wherein the at least one closure retainer is coupled to the lip flange, the at least one closure retainer including an attachment member coupled and extending radially away from the lip flange and a ramp member coupled to and extending axially away from the attachment member towards the floor of the vial and parallel to the side wall.

Clause 33. The vial of clause 32, any other suitable clause, or any suitable combination of clauses, wherein the ramp member is offset from the side wall, a radially outer surface of the side wall, a radially inner surface of the ramp member, and a radially extending surface of the attachment member defining a space between the ramp member and the side wall.

1. A vial comprising:
a vial body including a side wall and a floor, an upper end of the side wall forming a mouth of the vial, the floor coupled to a lower end of the side wall and cooperating with the side wall to define a product-storage chamber;
a lip extending radially out from the side wall relative to an axis of rotation and extending axially along the side wall from the mouth towards the lower end of the side wall, a lower edge of the lip forming a lip flange;
at least one closure retainer coupled to the lip flange, the at least one closure retainer including an attachment member coupled and extending radially away from the lip flange, a ramp member coupled and extending axially away from the attachment member towards the floor of the vial, parallel to the side wall, and a stop member coupled to and extending axially away from the attachment member towards the floor of the vial, perpendicular to the side wall;
wherein the ramp member is offset from the side wall, a radially outer surface of the side wall, a radially inner surface of the ramp member, and a radially extending surface of the attachment member defining a space between the ramp member and the side wall to decrease cooling time of the vial, causing cycle time of the vial during manufacturing to decrease.

2. The vial of claim 1, wherein the vial comprises a plurality of closure retainers coupled to the lip flange, the plurality of closure retainers circumferentially spaced apart from one another around the vial.

3. The vial of claim 1, wherein the ramp member extends axially along the side wall closer towards the lower edge of the side wall than the lip flange.

4. The vial of claim 1, wherein the ramp member includes a radially extending ramp surface that engages a closure as the closure is rotated in an installation direction towards an installed position.

5. The vial of claim 1, wherein the ramp member is coupled to the attachment member at a radially outer portion of the attachment member.

6. The vial of claim 1, wherein the stop member is coupled to the attachment member at a circumferential end of the attachment member.

7. The vial of claim 6, wherein the stop member is coupled to the side wall.

8. The vial of claim 1, wherein the ramp member and the stop member are circumferentially spaced apart to define a closer-retainer gap.

9. The vial of claim 8, wherein the attachment member includes a closure-retainer surface on a radially extending surface of the attachment member, the closure-retaining surface extending between the ramp member and the stop member to engage a closure in an installed position.

10. The vial of claim 9, wherein the closure-retainer surface is offset from a radially extending ramp surface of the ramp member such that a lower end of the ramp surface is located further away from the mouth of the vial than the closure-retainer surface.

11. The vial of claim 1, wherein the stop member is configured to engage a closure in an installed position to block rotation of the closure in an installation direction.

12. The vial of claim 1, wherein the lip includes a plurality of projections extending radially outward from the lip.

13. The vial of claim 12, wherein the plurality of projections are circumferentially spaced apart from each other around the lip.

14. The vial of claim 12, wherein the plurality of projections are shaped to define recesses between each of the plurality of projections to decrease cooling time of the vial.

15. A child-resistant package comprising:
a vial having a side wall forming a mouth of the vial and a floor coupled to a lower end of the side wall and cooperating with the side wall to define a product-storage chamber, the side wall including a lip extending radially out from the side wall relative to an axis of rotation and axially along the side wall from the mouth towards the lower end of the side wall and a plurality of closure retainers coupled to a lower edge of the lip, each one of the plurality of closure retainers including an attachment member coupled and extending radially away from the lip, a ramp member coupled to and extending axially away from the attachment member towards the floor of the vial, and a stop member coupled to and extending axially away from the attachment member towards the floor of the vial;
a closure including a top wall, a side wall being arranged to extend downwardly away from an outer perimeter of the top wall, and a plurality of closure anchors coupled to an inside surface of the side wall and spaced circumferentially from one another about the axis of rotation, the closure configured to mount on the vial to assume an installed position closing the mouth of the vial when rotated relative to the vial about the axis of rotation in an installation direction until each of the plurality of closure retainers overlies a corresponding closure anchor to block separation of the closure from the vial along the axis of rotation,
wherein the ramp member of a corresponding one of the plurality of closure retainers is offset from the side wall of the vial, a radially outer surface of the side wall, a radially inner surface of the ramp member, and a radially extending surface of the attachment member defining a space between the ramp member and the side wall to decrease cooling time of the vial, causing cycle time of the vial during manufacturing to decrease.

16. The child-resistant package of claim 15, wherein the ramp member includes a radially extending ramp surface that engages the corresponding closure anchor as the closure is rotated in the installation direction towards the installed position.

17. The child-resistant package of claim 16, wherein the attachment member includes a closure-retainer surface on a radially extending surface of the attachment member extending between the ramp member and the stop member that engages the corresponding closure anchor in the installed position.

18. The child-resistant package of claim 15, wherein the lip includes a plurality of projections extending radially outward from the lip.

19. The child-resistant package of claim 18, wherein the plurality of projections are shaped to define spaces between each of the plurality of projections to decrease cooling time of the vial.

20. A vial comprising:
a vial body include a side wall and a floor, an upper end of the side wall forming a mouth of the vial, the floor coupled to a lower end of the side wall and cooperating with the side wall,
a lip extending radially out from the side wall relative to an axis of rotation and extending axially along the side wall from the mouth towards the lower end of the side wall, a lower edge of the lip forming a lip flange,
at least one closure retainer coupled to the lip flange, the at least one closure retainer including an attachment member coupled and extending radially away from the lip flange and a ramp member coupled to and extending axially away from the attachment member towards the floor of the vial and parallel to the side wall,
wherein the ramp member is offset from the side wall, a radially outer surface of the side wall, a radially inner surface of the ramp member, and a radially extending surface of the attachment member defining a space between the ramp member and the side wall.
